(19) United States
(12) Patent Application Publication
(10) Pub. No.: US 2025/0299496 A1
(43) Pub. Date: Sep. 25, 2025

(54) ELECTRONIC DEVICE AND METHOD FOR IDENTIFYING EXTERNAL OBJECT OF PLATOONING VEHICLES

(71) Applicant: THINKWARE CORPORATION, Seongnam-si (KR)

(72) Inventors: Yosep PARK, Seongnam-si (KR); Taekyu HAN, Seongnam-si (KR)

(21) Appl. No.: 19/083,458

(22) Filed: Mar. 19, 2025

(30) Foreign Application Priority Data
Mar. 19, 2024 (KR) 10-2024-0038121

(51) Int. Cl. G06V 20/58; G06T 7/11; G06V 10/25; H04W 4/46

(52) U.S. Cl. CPC G06V 20/58; G06T 7/11; G06V 10/25; H04W 4/46; G06T 2207/30252

(57) ABSTRACT

An electronic device for platooning vehicles may obtain a forward video, generate cropped videos by cropping the forward video, transmit the forward video or at least one of the cropped videos to each of other electronic devices, obtain, from an external object included in the forward video or at least one of the cropped videos, first information related to the external object, receive, from the other electronic devices, second information related to the external object that is obtained from the external object included in the forward video or at least one of the cropped videos, and identify the external object, based on the first information and the second information.

### CROSS-REFERENCE TO RELATED APPLICATIONS

This application is based on and claims priority under 35 U.S.C. § 119 to Korean Patent Application No. 10-2024-0038121, filed on Mar. 19, 2024, in the Korean Intellectual Property Office, the disclosure of which is incorporated by reference herein its entirety.

### BACKGROUND

### Field

The disclosure relates to an electronic device and method for identifying an external object of platooning vehicles.

### Description of Related Art

Platooning is a technology that controls the autonomous driving of two or more vehicles. Platooning vehicles may drive in a certain formation. Platooning may enhance fuel efficiency by reducing inter-vehicle gaps and hence air resistance, reducing the risk of accidents, and reducing traffic congestion by controlling the flow of vehicles. Platooning vehicles may include a leading vehicle and following vehicles. An electronic device equipped to the leading vehicle may control platooning. For example, the electronic device may identify external objects in front of the leading vehicle, set up a driving route based on the external objects, and control the speed and direction of the vehicles.

### SUMMARY

An electronic device disposed in a leading vehicle may identify an external object from an image obtained through a camera. Methods for reducing the data processing burden of an electronic device are being studied.

There is provided an electronic device disposed in a leading vehicle among platooning vehicles. The electronic device may comprise a processor, memory storing instructions, and a camera. The instructions may, when executed by the processor, cause the electronic device to obtain a forward video related to an area in front of the leading vehicle, using the camera, generate cropped videos by cropping the forward video, transmit the forward video or at least one of the cropped videos to each of other electronic devices respectively disposed in following vehicles, obtain, from an external object included in the forward video or at least one of the cropped videos, first information related to the external object, receive, from the other electronic devices, second information related to the external object that is obtained from the external object included in the forward video or at least one of the cropped videos, and identify the external object, based on the first information and the second information.

There is provided an electronic device disposed in a leading vehicle among platooning vehicles. The electronic device may comprise a processor, memory storing instructions, and cameras. The instructions may, when executed by the processor, cause the electronic device to obtain forward videos related to an area in front of the leading vehicle, using each of the cameras, transmit the forward videos to each of other electronic devices respectively disposed in following vehicles, obtain, from an external object included in at least one of the forward videos, first information related to the external object, receive, from the other electronic devices, second information related to the external object that may be obtained from the external object included in at least one of the forward videos, and identify the external object, based on the first information and the second information.

There is provided a method of an electronic device disposed in a leading vehicle among platooning vehicles. The method may comprise obtaining a forward video related to an area in front of the leading vehicle, using a camera of the electronic device, generating cropped videos by cropping the forward video, transmitting the forward video or at least one of the cropped videos to each of other electronic devices respectively disposed in following vehicles, obtaining, from an external object included in the forward video or at least one of the cropped videos, first information related to the external object, receiving, from the other electronic devices, second information related to the external object that may be obtained from the external object included in the forward video or at least one of the cropped videos, and identifying the external object, based on the first information and the second information.

While the vehicles are controlled in platooning mode, the electronic device may quickly and accurately identify an external object by identifying the external object using information obtained by the electronic device and information provided from other electronic devices.

### BRIEF DESCRIPTION OF THE DRAWINGS

FIG. 1 schematically illustrates platooning vehicles.

FIG. 2 is a block diagram illustrating electronic devices for platooning vehicles according to an embodiment.

FIG. 3A schematically illustrates a visual field according to a field of view of a camera.

FIG. 3B illustrates an image according to a field of view.

FIG. 4 is a flowchart illustrating operations of an electronic device for identifying an external object.

FIG. 5 illustrates platooning vehicles.

FIGS. 6A, 6B, and 6C illustrate a forward video and cropped videos.

FIG. 7A is a flowchart illustrating operations of an electronic device for identifying an external object by transmitting cropped videos to other electronic devices.

FIG. 7B is a flowchart illustrating operations of an electronic device for identifying an external object through a distributed computing or edge computing scheme.

FIG. 7C is a signal flowchart illustrating a procedure for discovering other electronic devices of other vehicles for requesting task sharing by an electronic device of a vehicle according to a distributed computing scheme.

FIG. 8 is a flowchart illustrating an operation of identifying an external object based on a main video and sub videos by an electronic device according to an embodiment.

FIG. 9 schematically illustrates a process of processing a main video and sub videos by the operations of FIG. 8.

FIG. 10 is a flowchart illustrating operations of an electronic device using a plurality of cameras.

FIG. 11 is a flowchart illustrating an operation of identifying an external object based on a main video and sub videos by an electronic device according to an embodiment.

FIG. 12 is a block diagram illustrating an example of an autonomous driving system of a vehicle according to an embodiment.

FIG. 13 is a block diagram illustrating an example of an autonomous driving moving object according to an embodiment.

FIG. 14 is a block diagram illustrating an example of an autonomous driving moving object according to an embodiment.

FIG. 15 illustrates an example of a gateway related to a user device according to various embodiments.

FIG. 16 is a view illustrating operations of an electronic device training a neural network based on a set of training data according to an embodiment.

FIG. 17 is a block diagram illustrating an electronic device according to an embodiment.

FIG. 18A illustrates an example of a vehicle performing platooning.

FIG. 18B illustrates an example of a vehicle performing platooning.

FIGS. 19A, 19B, 19C, and 19D illustrate various scenarios for radio resource allocation for direct communication between electronic devices according to an embodiment.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 100). For example, a processor (e.g., the processor 110) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, embodiments of the disclosure are described with reference to the accompanying drawings.

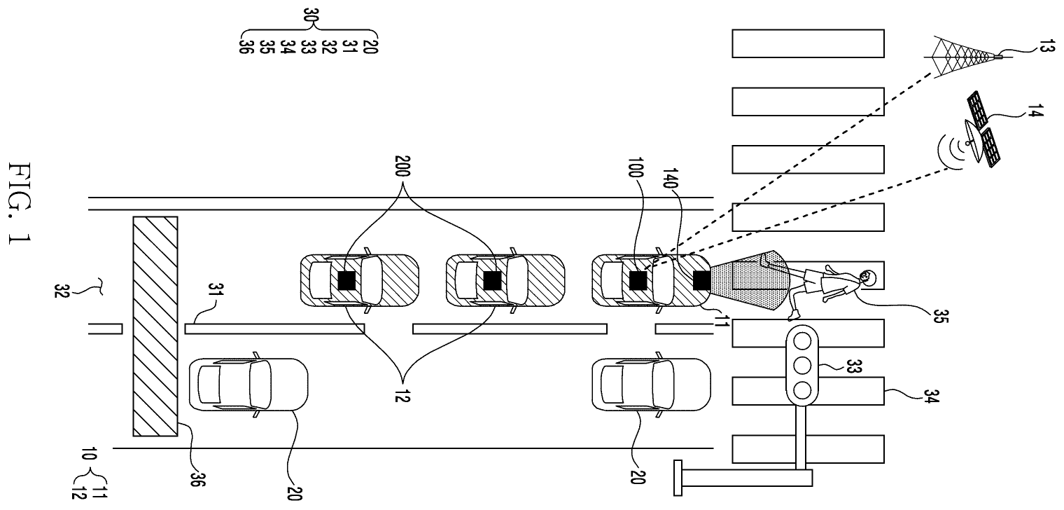

FIG. 1 schematically illustrates platooning vehicles.

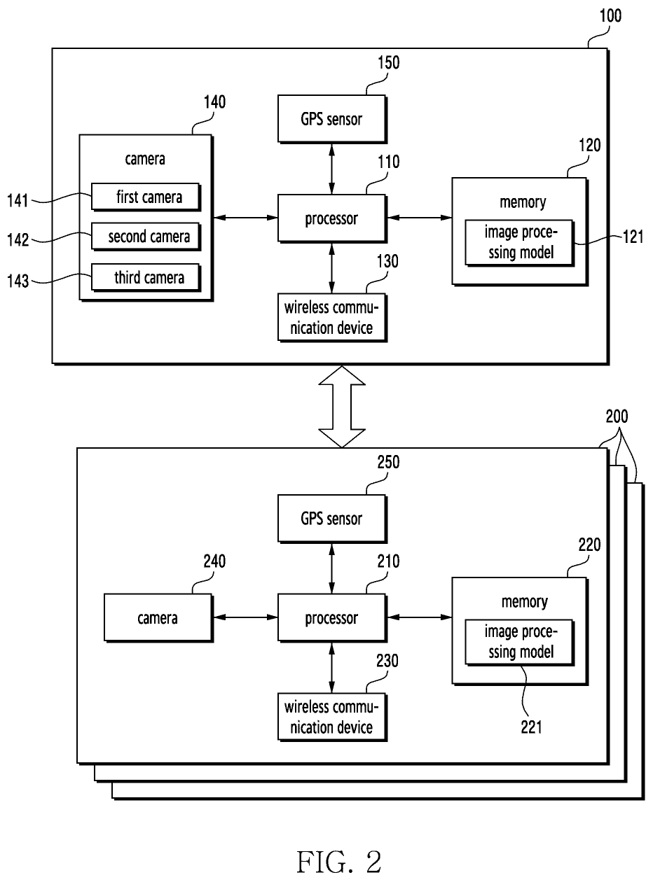

Platooning is a technology of controlling two or more vehicles 10 forming a platoon to drive while maintaining a designated formation. Each of the vehicles 10 may include electronic devices (e.g., the electronic device 100 of FIG. 2 and other electronic devices 200) for platooning. The electronic devices 100 and 200 may share control information about the vehicles 10 and information collected through the electronic devices 100 and 200 respectively disposed in the vehicles 10 in real-time using wireless communication technology. The wireless access technologies for exchanging information between the electronic devices 100 and 200 shown in FIG. 1 may use various wireless access technologies, such as vehicle-to-infrastructure (V2I), vehicle-to-device (V2D), vehicle-to-vehicle (V2V), vehicle-to-pedestrian (V2P) or such vehicle-to-everything (V2X), cellular 5G new radio (NR) sidelink, 802-11-based dedicated short range communication (DSRC), or the like.

The vehicles 10 may be divided into a leading vehicle 11 and following vehicles 12. The leading vehicle 11 may be referred to as a vehicle positioned at the front among the platooning vehicles 10, and the following vehicles 12 may be referred to as the remaining vehicles except for the leading vehicle 11. The electronic device 100 disposed in the leading vehicle 11 may be used to control the overall operation of the platooning. For example, since the leading vehicle 11 is positioned at the front in the platoon, the leading vehicle 11 may include more electronic components (e.g., radar, lidar, or cameras) than the other vehicles. The electronic device 100 may obtain various pieces of information than other electronic devices 200 may. An electronic device 100 according to an embodiment may have higher specifications than other electronic devices 200.

The electronic device 100 may transmit and/or receive data to and/or from an external electronic device (e.g., the base station 13 and/or the satellite 14). For example, the electronic device 100 may receive data including information related to the driving route from an external electronic device 13 or 14 to determine the driving route and transmit data including information related to the real-time position of the platoon to the external electronic device 13 or 14.

The electronic device 100 may be configured to control the driving of the vehicles 10 based on information related to the platooning vehicles 10 (e.g., driving route, driving speed, intervals between the vehicles 10, and/or formation of the platoon) and/or information related to the ambient environment. For example, the electronic device 100 may transmit a signal for controlling platooning to each of the other electronic devices 200 respectively disposed in the following vehicles 12. The other electronic devices 200 may be configured to control driving of following vehicles 12 based on the signal received from the electronic device 100.

The information related to the ambient environment may include information related to the external object 30. For example, the external object 30 may be an object positioned around the driving route of the vehicles 10, and may be an object that should be considered for safe driving. For example, the external object 30 may include, but is not limited to, other vehicles 20, lines 31, lanes 32, traffic lights 33, crosswalks 34, pedestrians 35, and/or speed bumps 36.

The electronic device 100 according to an embodiment may include a camera (e.g., the camera 140 of FIG. 2). The camera 140 may capture the area in front of the leading vehicle 11 to obtain a forward image and/or forward video. For example, information related to the surrounding environment may be identified through the forward image and/or forward video obtained through camera 140. However, the disclosure is not limited thereto. The camera 140 may obtain an image and/or video of the surrounding environment of the leading vehicle 11 by capturing the side and rear of the leading vehicle 11.

According to an embodiment, since the electronic device 100 disposed in the leading vehicle 11 is positioned at the front of the platoon, it may be configured to provide various functions. For example, since other electronic devices 200 disposed in the following vehicles 12 follow the leading vehicle 11, it may be difficult to obtain information about the forward area of the platoon, so that information about the forward area may be obtained through the electronic device 100. The electronic device 100 may determine a driving route of the group based on the information about the forward area, and may transmit a signal for driving control of the following vehicles 12 so that the vehicles 10 drive based on the determined driving route. The electronic device 100 may receive information related to the environment around the following vehicles 12 from the other electronic devices 200, and control the driving of the platoon according to the information. The electronic device 100 may transmit and/or receive data with the external electronic devices 13 and 14.

Since the electronic device 100 provides various functions, there may be much information processed by the electronic device 100 and many operations performed by the electronic device 100. In order to provide various functions of the electronic device 100, high-spec electronic components may be required, or errors may sometimes occur. For example, as the electronic device 100 processes various pieces of information, the timing of identifying the external object 30 from the forward video obtained through the camera 140 may be delayed or an error in identification of the external object 30 may occur. A delay in identifying the external object 30 or an error in identifying the external object 30 may cause an accident of the vehicles 10.

The electronic device 100 according to an embodiment may transmit the forward video obtained through the camera 140 or cropped videos generated from the forward video to other electronic devices 200, and use information provided from other electronic devices 200 to identify the external object 30. Accordingly, it is possible to reduce the throughput of data for identifying the external object 30 to be processed by the electronic device 100, ease the burden of data processing, and accurately identify the external object 30.

An electronic device 100 according to an embodiment is described below with reference to the drawings.

FIG. 2 is a block diagram illustrating electronic devices for platooning vehicles according to an embodiment.

Referring to FIG. 2, an electronic device 100 according to an embodiment may include a processor 110, memory 120, a wireless communication device 130, a camera 140, and/or a global positioning system (GPS) sensor 150. The electronic device 100 according to an embodiment may be referred to as an electronic device disposed in a leading vehicle (e.g., the leading vehicle 11 of FIG. 1).

For example, the processor 110, the memory 120, the wireless communication device 130, a camera 140, and/or a GPS sensor 150 may be electrically and/or operatively connected to each other by an electronic component such as a communication bus. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware.

Although FIG. 2 illustrates that the processor 110, the memory 120, the camera 140, the wireless communication device 130, and/or the GPS sensor 150 in different blocks, the disclosure is not limited thereto. Some of the pieces of hardware of FIG. 2 may be implemented as a single integrated circuit such as a system on chip (SoC) or a single package.

The memory 120 according to an embodiment may store instructions. The processor 110 may be configured to process data based on the instructions stored in the memory 120. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor or a structure of a multi-core processor such as a dual core, a quad core, a hexa core, or an octa core.

According to an embodiment, the memory 120 may include a hardware component for storing data and/or instructions executable by the processor 110. The memory 120 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC). For example, the memory 120 of the electronic device 100 may include an image processing model (e.g., a neural network model) 121. The electronic device 100 may identify an external object (e.g., the external object 30 of FIG. 1) based on the image processing model (e.g., a neural network model) stored in the memory 120. Hereinafter, the image processing model may be referred to as a neural network model.

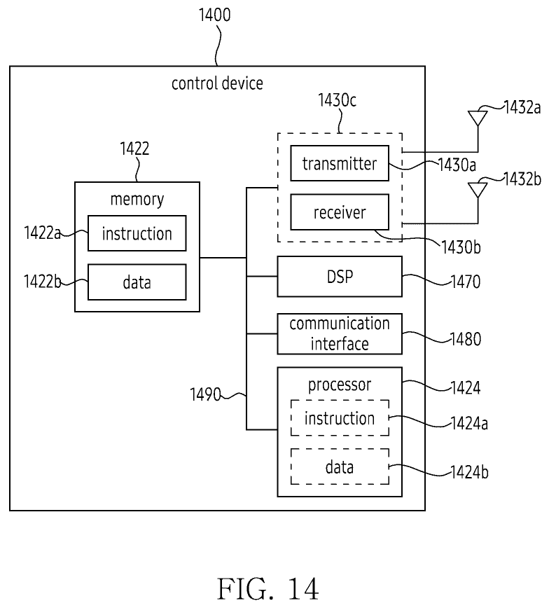

According to an embodiment, the wireless communication device 130 may be used for wireless communication with other electronic devices 200 and/or an external electronic device. For example, the electronic device 100 may be configured to perform wireless communication with an external electronic device (e.g., a base station (e.g., the base station 13 of FIG. 1) and/or a satellite (e.g., the satellite 14 of FIG. 1)) and other electronic devices 200 using the wireless communication device 130. The wireless communication device 130 may be electrically connected to an antenna (e.g., the antenna 1432a or 1432b of FIG. 14) for transmitting and/or receiving a signal. The wireless communication device 130 may convert an analog signal provided from the processor 110 into a digital signal and upconvert a baseband signal into a radio frequency (RF) signal. The electronic device 100 may obtain information related to the real-time position of the platoon using the GPS sensor 150 and transmit data including the information to the external electronic devices 13 and 14 using the wireless communication device 130. The electronic device 100 may transmit signals for controlling driving of the following vehicles (e.g., the following vehicles 12 of FIG. 1) to the wireless communication device 230 of the other electronic devices 200. The other electronic devices 200 may receive the signal through the wireless communication device 230.

According to an embodiment, the camera 140 may include a lens assembly or an image sensor. The lens assembly may collect light emitted or reflected from an object whose image is to be taken. The lens assembly may include one or more lenses. For example, the camera 140 may include a plurality of lens assemblies. For example, some of the plurality of lens assemblies of the camera 140 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 100 may include a flash for the camera 140. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the electronic device 100 may identify the ambient environments of the leading vehicle 11 using the camera 140. For example, the electronic device 100 may identify an external object 30 based on an image obtained through the camera 140. For example, the electronic device 100 may identify the external object 30 corresponding to the image obtained through the camera 140 using the image processing model 121 (e.g., a neural network model). For example, the electronic device 100 may obtain an image corresponding to another vehicle 20 through the camera 140 and identify the other vehicle 20 from the image.

Other electronic devices 200 disposed in the following vehicles 12 may include substantially the same components as the electronic device 100 disposed in the leading vehicle 11. For example, each of the other electronic devices 200 may include a processor 210, memory 220, a wireless communication device 230, a camera 240, and/or a GPS sensor 250. The above descriptions of the components of the electronic device 100 may be applied to the components of the other electronic devices 200 in substantially the same manner. For example, the memory 220 may include an image processing model 221.

Since the vehicles 10 drive in a designated formation, the camera 240 of other electronic devices 200 may obtain an image that the camera 140 of the electronic device 100 may not obtain at a specific timing. According to an embodiment, the other electronic devices 200 may transmit information related to the image obtained through the camera 240 and/or information related to the external object 30 identified from the image to the electronic device 100. The electronic device 100 may identify surrounding environments of the platoon based on the information received from the other electronic devices 200, and control the driving of the platoon based on the surrounding environments.

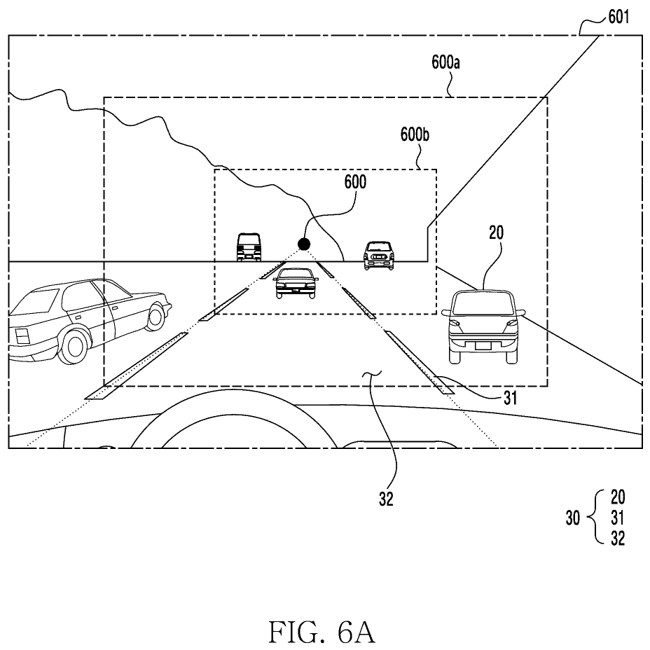

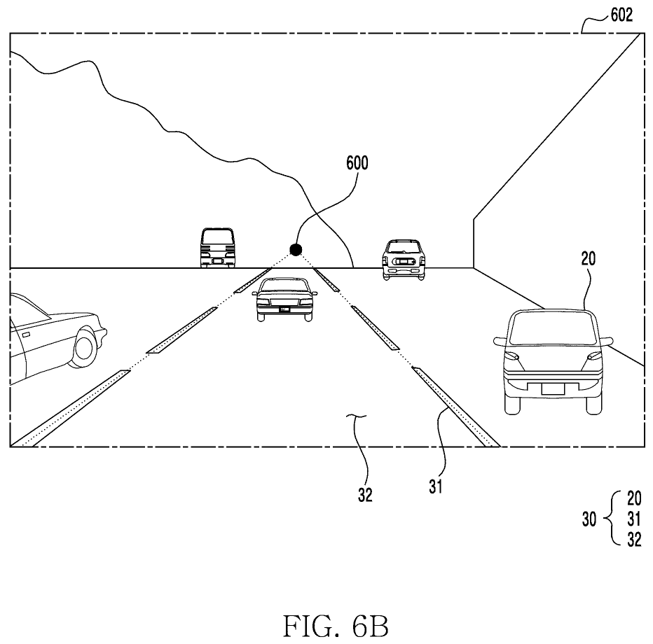

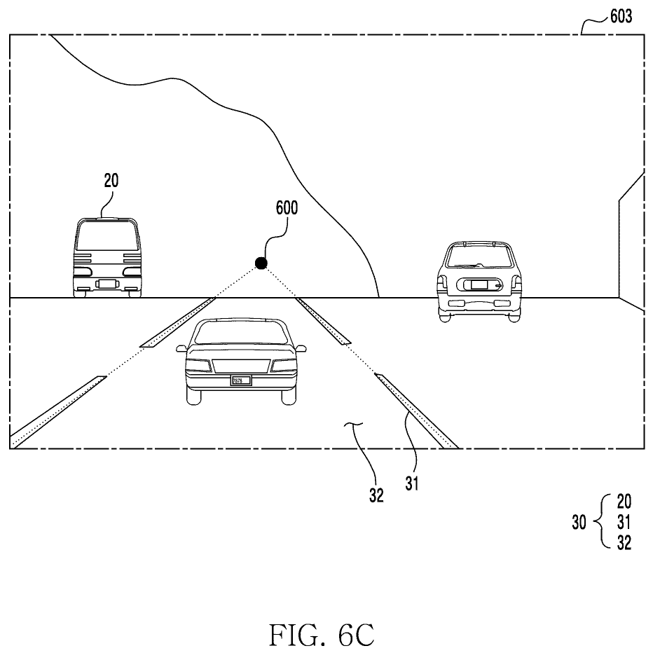

According to an embodiment, the camera 140 may include a plurality of cameras 141, 142, and 143. For example, the camera 140 may include a first camera 141, a second camera 142, and/or a third camera 143, but the disclosure is not limited thereto. According to an embodiment, the first camera 141, the second camera 142, and/or the third camera 143 may have different fields of view. For example, the first camera 141 may include a lens for obtaining a first image (e.g., the first image 601 of FIG. 6A) based on the first field of view. For example, the second camera 142 may include a lens for obtaining a second image (e.g., the second image 602 of FIG. 6B) based on the second field of view. For example, the third camera 143 may include a lens for obtaining a third image (e.g., the third image 603 of FIG. 6C) based on the third field of view. The first field of view, the second field of view, and the third field of view may be different from each other.

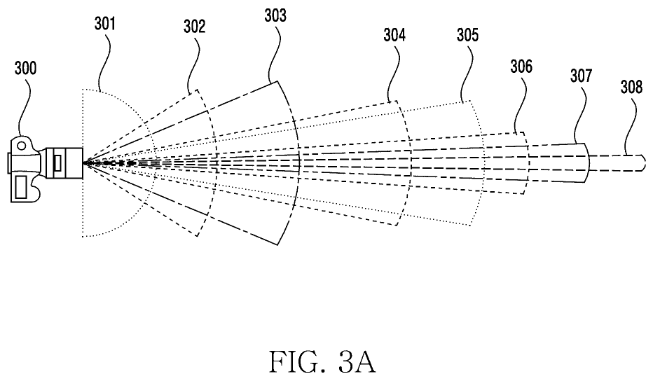

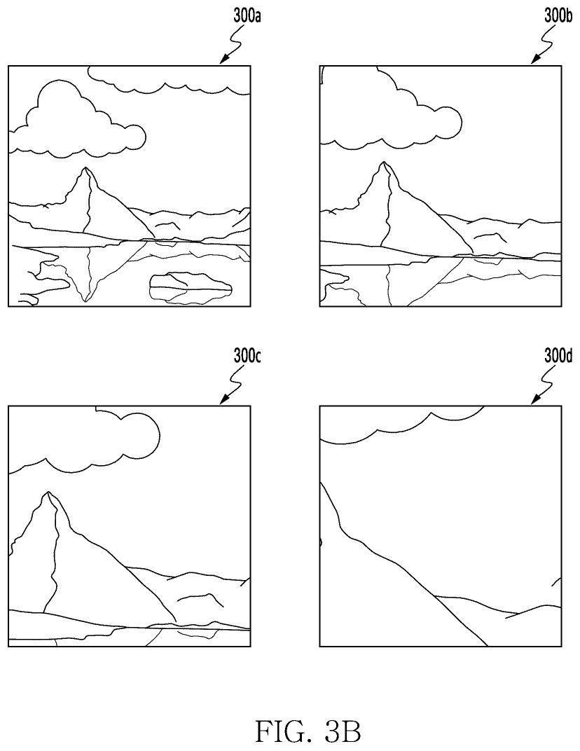

FIG. 3A schematically illustrates a visual field according to a field of view of a camera. FIG. 3B illustrates an image according to a field of view;

Referring to FIG. 3A, the camera 300 may obtain an image and/or video, which is a set of images, based on a field of view determined according to the focal length of the lens. The focal length is the distance at which an image is formed on the film from the lens. The field of view may be determined according to the focal length. The shorter the focal length, the wider the field of view, and the longer the focal length, the narrower the field of view.

For example, when the focal length is about 7.5 mm, the field of view 301 may be about 180 degrees. When the focal length is about 28 mm, the field of view 302 may be about 75 degrees. When the focal length is about 50 mm, the field of view 303 may be about 47 degrees. When the focal length is about 105 mm, the field of view 304 may be about 23 degrees. When the focal length is about 135 mm, the field of view 305 may be about 18 degrees. When the focal length is about 300 mm, the field of view 306 may be about 8 degrees. When the focal length is about 500 mm, the field of view 307 may be about 5 degrees. When the focal length is about 1,000 mm, the field of view 308 may be about 2 degrees.

The camera 300 may be distinguished according to the focal length. For example, a camera having a focal length of about 7 mm to 15 mm may be a camera including a fisheye lens. A camera having a focal length of about 15 mm to 35 mm may be a camera including a wide-angle lens. A camera having a focal length of about 38 mm to about 55 mm may be a camera including a standard lens. A camera having a focal length of about 70 mm to about 1,000 mm may be a camera including a telephoto lens.

The video 300a of FIG. 3B illustrates an example of a video obtained through a camera having a focal length of about 24 mm. The video 300b of FIG. 3B illustrates an example of a video obtained through a camera having a focal length of about 35 mm. The video 300c of FIG. 3B illustrates an example of a video obtained through a camera having a focal length of about 50 mm. The video 300d of FIG. 3B illustrates an example of a video obtained through a camera having a focal length of about 100 mm.

Referring to FIG. 3B, the field of view may determine a range of a video obtained through the camera 300. The wider the field of view, the wider the capturing range of the camera 300 and the smaller the subject to be captured. The shorter the field of view, the narrower the capturing range, and the larger the subject to be captured. For example, information about the most subjects may be obtained from the video 300a of FIG. 3B, but it may be difficult to accurately distinguish subjects due to the wide capturing range. For example, from the video 300d of FIG. 3B, it may be easy to accurately distinguish a subject, but because the capturing range is narrow, information about the fewest subject may be obtained. Depending on the field of view, the influence of radial distortion may be different. For example, when the field of view is wide, since the influence of radiation distortion is large, the accurate position of the subject may be distorted.

As described with reference to FIGS. 3A and 3B, the amount of information that may be obtained from a video and the accuracy of the information may vary depending on the characteristics of the camera 300. For example, depending on the field of view of the camera (e.g., the camera 140 of FIG. 2) of the electronic device (e.g., the electronic device 100 of FIG. 2), the characteristics of identifying an external object (e.g., the external object 30 of FIG. 1) from the video obtained through the camera 140 may differ. In order to accurately identify the external object 30, a video based on a relatively small field of view may be required. In order to obtain various pieces of information about the surrounding environment of vehicles (e.g., the vehicles 10 of FIG. 1), a video based on a relatively large field of view may be required.

The electronic device 100 according to an embodiment may accurately and variously identify the external object 30 and the surrounding environment by obtaining or generating videos based on different fields of view and identifying the external object 30 from the videos. The electronic device 100 may transmit at least some of the videos to the other electronic devices 200, and identify the external object 30 based on information (e.g., first information) related to the external object 30 obtained by the electronic device 100 and information (e.g., second information) related to the external object 30 provided by the other electronic devices 200.

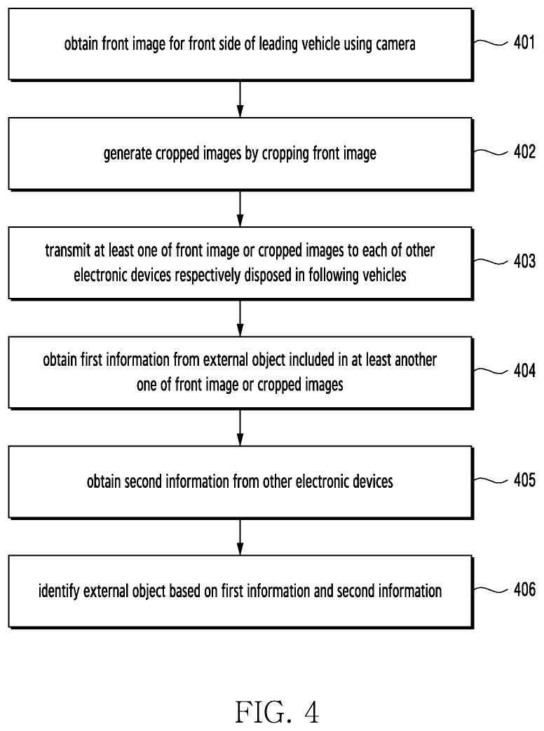

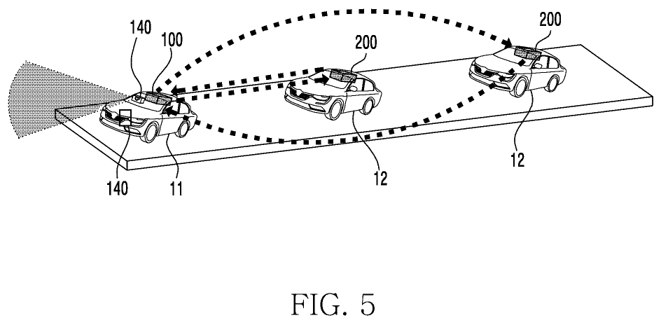

FIG. 4 is a flowchart illustrating operations of an electronic device for identifying an external object. FIG. 5 illustrates platooning vehicles. FIGS. 6A, 6B, and 6C illustrate a forward video and cropped videos.

The operations of FIG. 4 may be operations of an electronic device (e.g., the electronic device 100 of FIG. 2) caused when instructions stored in the memory (e.g., the memory 120 of FIG. 2) are executed by the processor (e.g., the processor 110 of FIG. 1).

Referring to FIG. 4, in operation 401, the electronic device 100 may obtain a forward video of the area in front of the leading vehicle (e.g., the leading vehicle 11 of FIG. 5) using the camera 140.

For example, when executing the instructions stored in the memory 120, the processor 110 may obtain a forward video of the area in front of the leading vehicle 11, captured through the camera 140. Referring to FIG. 5, the leading vehicle 11 may be positioned in front of the following vehicles 12. The camera 140 disposed in the leading vehicle 11 may be disposed on the front of the leading vehicle 11 so as to capture the area in front of the leading vehicle 11. While the leading vehicle 11 is driving, the camera 140 may generate a forward video by capturing a video of the area in front of the leading vehicle 11. The processor 110 may obtain a forward video generated by the camera 140.

In operation 402, the electronic device 100 may generate cropped videos by cropping the forward video.

For example, when executing the instructions stored in the memory 120, the processor 110 may generate a plurality of cropped videos by cropping the forward video obtained through the camera 140 into different sizes. According to an embodiment, the cropped videos may be generated based on the vanishing point (e.g., the vanishing point 600 of FIGS. 6A to 6C) of the forward video.

The first video 601 shown in FIG. 6A illustrates an example of the forward video. An external object (e.g., another vehicle 20, a line 31, and/or a lane 32) may be included in the first video 601. Referring to FIG. 6A, the first video 601 may be a video based on a first field of view. For example, the first field of view may be wider than the second field of view and the third field of view to be described below. For example, the camera (e.g., the camera 140 of FIG. 2) may be an ultra-wide-angle camera for a wide capturing range, but the disclosure is not limited thereto. The vanishing point 600 of the forward video is a point to which parallel straight lines converge when the parallel straight lines face in the same direction in an actual physical space. The processor (e.g., the processor 110 of FIG. 2) may identify the vanishing point 600 in the forward video and set a region of interest (ROI) based on the vanishing point 600. The region of interest may be an area positioned in a predetermined area with respect to the vanishing point 600 in the video. For example, the processor 110 may set a first area 600a and a second area 600b as regions of interest with respect to the vanishing point 600. For example, the first area 600a may be an area larger than the second area 600b.

The video shown in FIG. 6B is a cropped video, and may be a second video 602 in which the first area 600a is cropped from the first video (e.g., the first video 601 of FIG. 6A) based on the first field of view. Since the second video 602 is a cropped video generated by cropping the first area (e.g., the first area 600a of FIG. 6A) from the first video 601, the second video 602 may have a narrower range than the first video 601. For example, the second video 602 may be a video based on a second field of view narrower than the first field of view. For example, when the camera 140 is an ultra-wide-angle camera, the second video 602 may be a video corresponding to a standard field of view, but the disclosure is not limited thereto. Since the second video 602 is based on the second field of view narrower than the first field of view, an area narrower than the first video 601 is displayed, but objects included in the first video may be displayed larger. For example, some of the external objects (e.g., another vehicle 20, line 31, and/or lane 32) included in the first video 601 may be enlarged and displayed in the second video 602.

The video shown in FIG. 6C is a cropped video, and may be a third video 603 generated by cropping the second area (e.g., the second area 600b of FIG. 6A) from the first video (e.g., the first video 601 of FIG. 6A) based on the first field of view. Since the third video 603 is a cropped video generated by cropping the second area 600b from the first video 601, it may have a narrower range than the first video 601 and the second video 602 (e.g., the second video 602 of FIG. 6B). For example, the third video 603 may be a video based on a third field of view narrower than the first field of view and the second field of view. For example, if the camera (e.g., the camera 140 in FIG. 2) is an ultra-wide-angle camera, the third video 603 may be a video corresponding to a narrower field of view than the standard field of view, but the disclosure is not limited thereto. Since the third video 603 is based on the third field of view narrower than the first field of view and the second field of view, the third video 603 may display a narrower area than the first video 601 and the second video 602, but may display an external object (e.g., another vehicle 20, line 31, and/or lane 32) included in the first video 601 and the second video 602 in a larger size. For example, the external object 30 included in the first video 601 and the second video 602 may be further enlarged and displayed in the third video 603. The second video 602 and the third video 603 shown in FIGS. 6B and 6C are exemplary, and cropped videos are not limited thereto. Alternatively, the first video 601, the second video 602, and the third video 603 may be videos captured by different cameras (e.g., the first camera 141, the second camera 142, and the third camera 143 of FIG. 2).

In operation 403, the electronic device 100 may transmit at least one of the forward video or the cropped video to each of the other electronic devices 200 respectively disposed in the following vehicles 12.

For example, referring to FIG. 5, when executing the instructions stored in the memory 120, the processor 110 may transmit data including the forward video and/or cropped videos to each of the other electronic devices 200 using a wireless communication device (e.g., wireless communication device 130 of FIG. 2). The processor 110 may transmit both the forward video and the cropped videos to each of the other electronic devices 200, or may transmit some of the forward video or the cropped videos to each of the other electronic devices 200.

According to an embodiment, the processor 110 may resize and transmit the forward video or cropped videos to be transmitted in order to reduce the capacity of data. As the resized forward video or cropped videos are transmitted, throughput processed through the wireless communication device 130 may be reduced. According to an embodiment, the processor 110 may resize the forward video or cropped videos to a size input to the neural network model of the other electronic devices 200. Since other electronic devices 200 do not require high-resolution (e.g., 4K, full high definition (FHD)) videos to identify the external object 30 from the forward video or cropped videos, the processor 110 may compress the forward video or cropped videos into below-HD videos and transmit the same.

In operation 404, the electronic device 100 may obtain first information from the external object 30 included in at least one of the forward video and the cropped videos.

For example, when executing the instructions stored in the memory 120, the processor 110 may identify the external object 30 included in at least one of the forward video or cropped videos and obtain first information related to the external object 30.

For example, the electronic device 100 may identify the external object 30 from the first video 601, which is the forward video. Referring to FIG. 6A, the electronic device 100 may identify the external object 30 included in the first video 601. Since the first video 601 is a video based on the widest field of view, the first video 601 may include the widest range of surrounding environment. Since the most information is included in the first video 601 obtained by the camera having the widest field of view, the electronic device 100 may include an AI accelerator such as a natural network processing unit (NPU) and/or a graphic processing unit (GPU) that has higher performance than the other electronic devices 200 for AI-based computer vision processing.

According to an embodiment, the electronic device 100 may identify the external object 30 from an image corresponding to the external object 30 using a neural network model trained in advance to identify the external object 30 and obtain the first information related to the external object 30. For example, the first information may include information related to the type, position, size, and/or current state of the external object 30.

In operation 405, the electronic device 100 may obtain second information from the other electronic devices 200.

For example, when executing the instructions stored in the memory 120, the processor 110 may receive second information related to the external object 30, obtained from the external object 30 included in at least one of the forward video or cropped videos, from the other electronic devices 200.

For example, the other electronic devices 200 may identify the external object 30 from the second video 602 and/or the third video 603, which are cropped videos. Referring to FIGS. 6B and 6C, the other electronic devices 200 may identify an external object 30 included in the second video 602 and/or the third video 603. Since the second video 602 and/or the third video 603 are videos based on a relatively narrow field of view, the external object 30 may be enlarged and displayed. Since the external object 30 is more accurately displayed in the second video 602 and/or the third video 603, the other electronic devices 200 may more accurately identify the external object 30 using the neural network model.

For example, in the first video 601, if the external object 30 is displayed too small to identify the external object 30, the external object 30 may be identified in the second video 602 and/or the third video 603. According to an embodiment, the other electronic devices 200 may identify the external object 30 from an image corresponding to the external object 30 using a neural network model trained in advance to identify the external object 30 and obtain second information related to the external object 30. For example, the second information may include information related to the type, position, size, and/or current state of the external object 30. Referring to FIG. 5, the other electronic devices 200 may transmit the second information to the electronic device 100, and the electronic device 100 may receive the second information from the other electronic devices 200.

In operation 406, the electronic device 100 may identify the external object 30 based on the first information and the second information.

For example, when executing the instructions stored in the memory 120, the processor 110 may identify an external object 30 positioned in front of the leading vehicle 11 by comprehensively considering the first and second information. Since the first information includes a lot of information and the second information includes accurate information, the electronic device 100 may accurately identify the surrounding environment based on the first information and the second information.

When the electronic device 100 analyzes both the forward video and the cropped videos in order to identify the external object 30, it may take a relatively long time because the throughput of the data is large. High specifications may be required for processing data of the electronic device 100. According to an embodiment, the electronic device 100 may identify the external object 30 from at least one (e.g., the first video 601 of FIG. 6A) among the forward video or cropped videos, and the other electronic devices 200 may identify the external object 30 from at least another one (e.g., the second video 602 and/or the third video 603) among the forward video or cropped videos, thereby relieving the electronic device 100 of the burden of data processing. According to an embodiment, since the electronic device 100 identifies the external object 30 based on the first information and the second information, it is possible to accurately identify a lot of information about the surrounding environment. Further, the data transmitted by the electronic device 100 to the other electronic devices 200 may be cropped videos cropped from the forward video, rather than the forward video itself.

Hereinafter, the operation of the electronic device 100 are described in more detail.

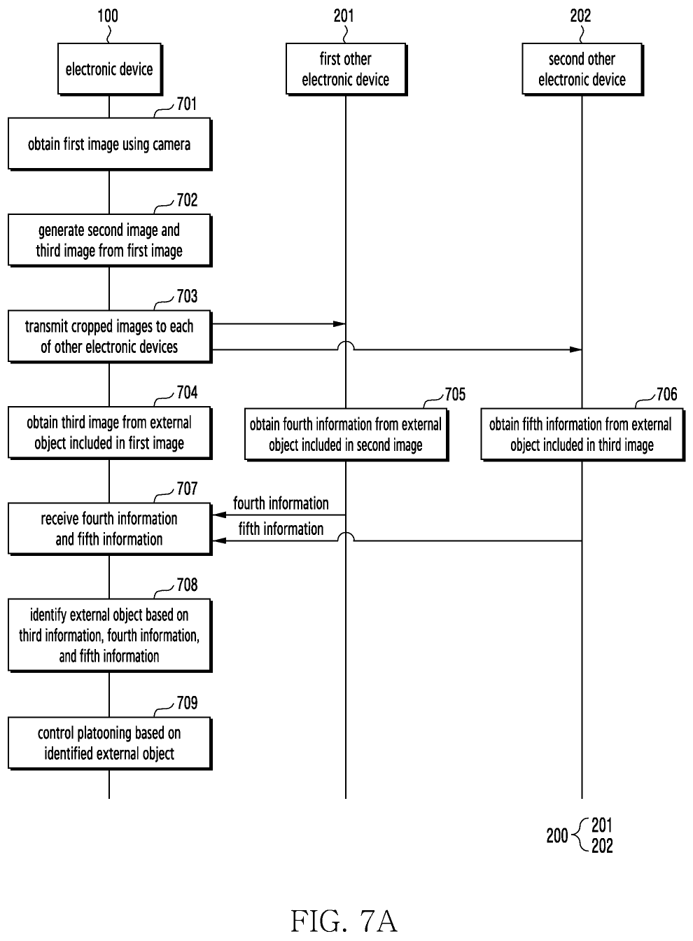

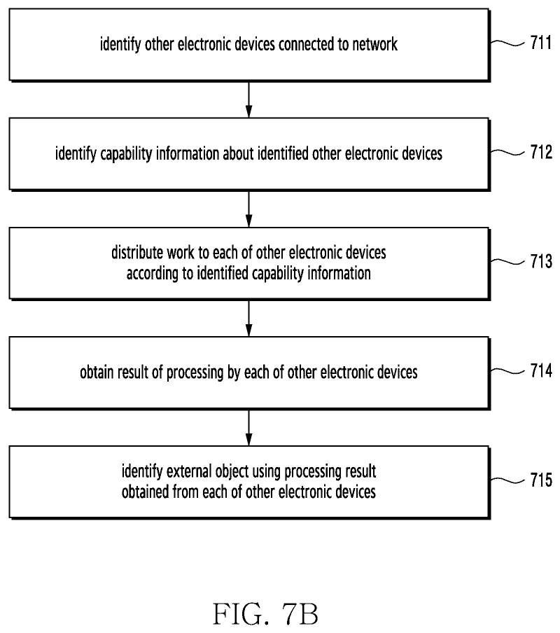

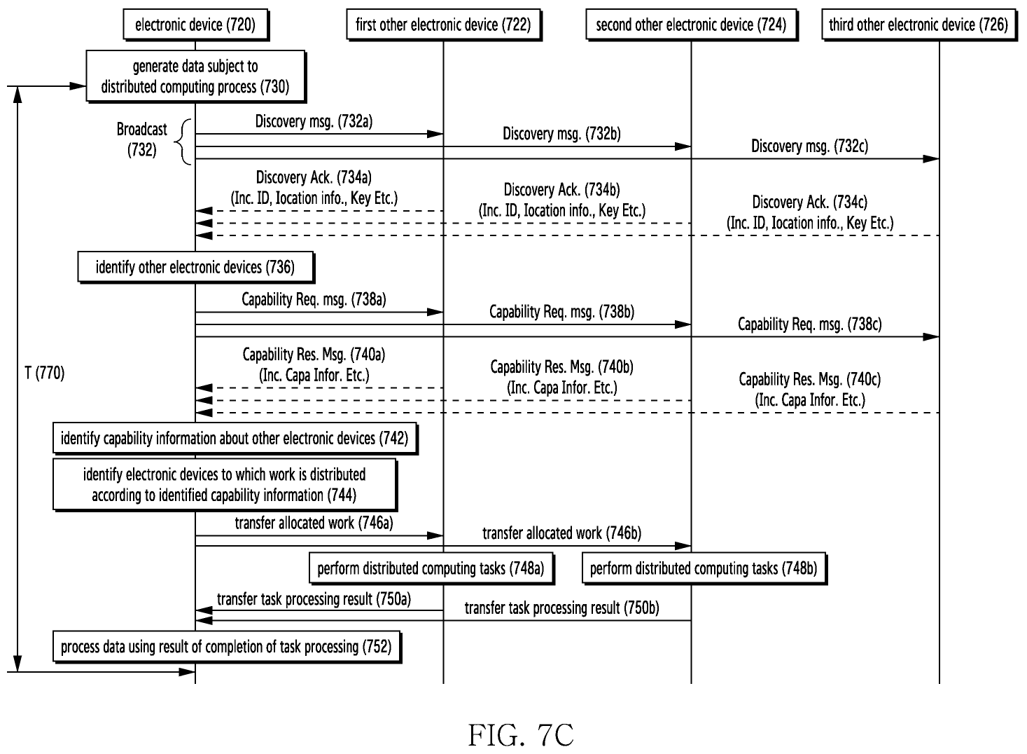

FIG. 7A is a flowchart illustrating operations of an electronic device for identifying an external object by transmitting cropped videos to other electronic devices.

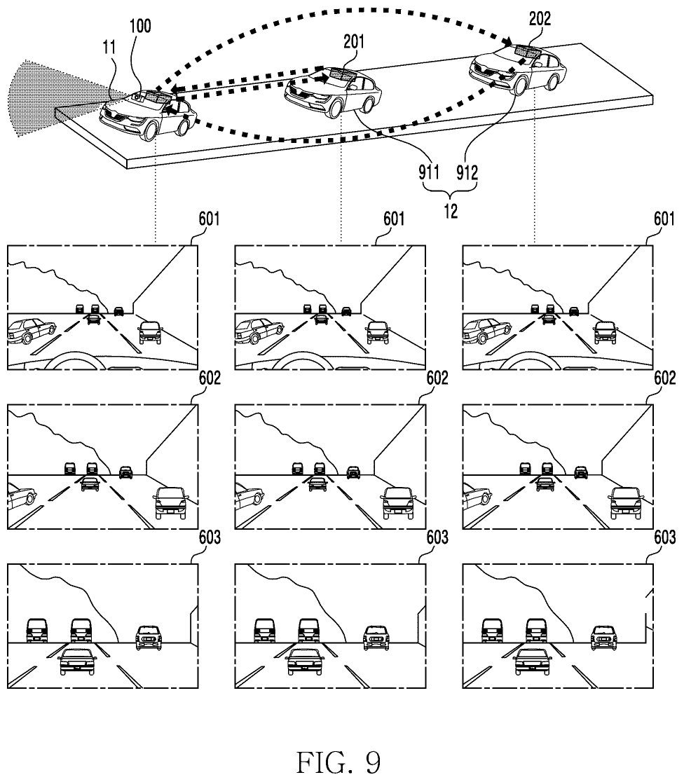

The operations of FIG. 7A may be operations of an electronic device (e.g., the electronic device 100 of FIG. 2 and the other electronic devices 200) that are caused when instructions stored in the memory (e.g., the memory 120 and memory 220 of FIG. 2) are executed by a processor (e.g., the processor 110 and processor 210 of FIG. 2). Hereinafter, the other electronic devices 200 are described as first other electronic device 201 disposed in a first following vehicle (e.g., the first following vehicle 911 of FIG. 9) among the following vehicles 12 and a second other electronic device 202 disposed in a second following vehicle (e.g., the second following vehicle 912 of FIG. 9) among the following vehicles 12, but the disclosure is not limited thereto.

Referring to FIG. 7A, in operation 701, the electronic device 100 may obtain a first video (e.g., the first video 601 of FIG. 6A) using the camera 140.

For example, the first video 601 may be a forward video of the area in front of the leading vehicle 11. Operation 701 may correspond to operation 401 of FIG. 4. For example, when executing the instructions stored in the memory 120, the processor 110 may obtain a forward video of the area in front of the leading vehicle 11, captured through the camera 140.

In operation 702, the electronic device 100 may generate a second video (e.g., the second video 602 of FIG. 6B) and a third video (e.g., the third video 603 of FIG. 6C) from the first video 601.

For example, the second video 602 and the third video 603 may be cropped videos generated by cropping a partial area of the first video 601. As described above, the second video 602 may be a cropped video in which the first area (e.g., the first area 600a of FIG. 6A) of the first video 601 is cropped, and the third video 603 may be a cropped video in which the second area (e.g., the second area 600b of FIG. 6A) of the first video 601 is cropped. Operation 702 may correspond to operation 402 of FIG. 4. For example, when executing the instructions stored in the memory 120, the processor 110 may generate a second video 602 and a third video 603 by cropping the first video 601 obtained through the camera 140 into different sizes.

In operation 703, the electronic device 100 may transmit cropped videos (e.g., a second video 602 and a third video 603) to each of the other electronic devices 200.

For example, when executing the instructions stored in the memory 120, the processor 110 may transmit the second video 602 to the first other electronic device 201 and transmit the third video 603 to the second other electronic device 202. Operation 703 may correspond to operation 403 of FIG. 4.

In operation 704, the electronic device 100 may obtain third information from an external object (e.g., the external object 30 of FIG. 1) included in the first video 601.

For example, the third information may correspond to the first information described above. For example, when executing the instructions stored in the memory 120, the processor 110 may obtain third information related to the external object 30 from the external object 30 included in the first video 601, which is a forward video. Operation 704 may correspond to operation 404 of FIG. 4.

In operation 705, the first other electronic device 201 may obtain fourth information from the external object 30 included in the second video 602.

In operation 706, the second other electronic device 202 may obtain the fifth information from the external object 30 included in the third video 603.

For example, the processor 210 of the first other electronic device 201 may obtain fourth information related to the external object 30 from the second video 602. The processor 210 of the second other electronic device 202 may obtain the fifth information related to the external object 30 from the third video 603. Since the second video 602 and/or the third video 603 are videos based on a relatively narrow field of view, the external object 30 may be enlarged and displayed. Since the external object 30 is more accurately displayed in the second video 602 and/or the third video 603, the first other electronic device 201 and the second other electronic device 202 may more accurately identify the external object 30 using the neural network model. The above-described second information may include fourth information and fifth information.

In operation 707, the electronic device 100 may receive fourth information and fifth information from the other electronic devices 200.

For example, when executing the instructions stored in the memory 120, the processor 110 may receive fourth information from the first other electronic device 201 and fifth information from the second other electronic device 202. Operation 707 may correspond to operation 405 of FIG. 4.

In operation 708, the electronic device 100 may identify the external object 30 based on the third information, the fourth information, and the fifth information.

For example, when executing the instructions stored in the memory 120, the processor 110 may identify the external object 30 based on the third information obtained from the first video 601, the fourth information received from the first other electronic device 201, and the fifth information received from the second other electronic device 202. The third information may include various pieces of information about the forward area, but when the external object 30 is displayed too small in the first video 601, it may be difficult to accurately identify the external object 30. The fourth information based on the second video 602 may include less information than the third information, but may include information related to the external object 30 more accurate than the third information. The fifth information based on the third video 603 may include less information than the third information and the fourth information, but may include information related to the external object 30 more accurate than the third information and the fourth information. The processor 110 may accurately identify various external objects 30 by identifying the external object 30 positioned in front of the leading vehicle 11 based on the third information, the fourth information, and the fifth information.

In operation 709, the electronic device 100 may control platooning based on the identified external object 30.

For example, when executing the instructions stored in the memory 120, the processor 110 may control platoon driving using a neural network model. For example, when the identified external object 30 is a traffic light, the processor 110 may control platooning based on the signal of the traffic light. For example, when the identified external object 30 is an obstacle, the processor 110 may determine a driving route to avoid the obstacle.

The electronic device 100 according to an embodiment may transmit cropped videos for the forward video to the other electronic devices 200 and identify the external object 30 from the forward video and the cropped videos. Since the analysis of the forward video may be performed by the electronic device 100, and the analysis of the cropped videos may be performed by the other electronic devices 200, the data throughput of the electronic device 100 may be reduced, and many external objects 30 may be accurately identified.

In the above examples, the electronic device 100 has been described as performing the operation of generating cropped videos from the forward video and transmitting the cropped videos to the other electronic devices 200, but the disclosure is not limited thereto. Alternatively, the electronic device 100 may transmit both the forward video and the cropped videos to the other electronic device 200. The electronic device 100 and the other electronic devices 200 may identify the external object 30 by processing one of the forward video and the cropped videos as a main video and the rest as sub videos.

FIG. 7B is a flowchart illustrating operations of an electronic device for identifying an external object through a distributed computing or edge computing scheme.

According to an embodiment, distributed computing and/or edge computing schemes may be used to identify an external object (e.g., the external object 30 of FIG. 6A). For example, the electronic device 100 and the other electronic devices 201 and 202 may process the first video 601 which is the forward video obtained using the camera of the leading vehicle 11 and the second video 602 and the third video 603 generated from the first video, using distributed computing and/or edge computing schemes. Hereinafter, an operation of the electronic device 100 for identifying an external object through a distributed computing scheme or an edge computing scheme is described. The operations of FIG. 7B may be operations of an electronic device (e.g., the electronic device 100 of FIG. 2) caused when instructions stored in the memory (e.g., the processor 110 of FIG. 1) are executed by the processor (e.g., the electronic device 100 of FIG. 2). Referring to FIG. 7B, in operation 711, the electronic device 100 may identify the other electronic devices 201 and second other electronic device 202 connected to the network.

The network may be referred to as a communication network for exchanging information between the electronic device 100 and the other electronic devices 201 and 202. The electronic device 100 may transmit a cropped video to the other electronic devices 201 and 202 connected to the network. Other electronic devices 201 and 202 may transmit information (e.g., fourth information or fifth information) to the electronic device 100 connected to the network. The electronic device 100 may identify the presence of the other electronic devices 201 and 202 connected to the network.

In operation 712, the electronic device 100 may identify capability information about the identified other electronic devices 201 and 202.

The electronic device 100 and the other electronic devices 201 and 202 may process the first video 601 which is the forward video obtained using the camera of the leading vehicle 11 and the second video 602 and the third video 603 generated from the first video, using distributed computing and/or edge computing schemes.

For example, the electronic device 100 of the leading vehicle 11 may obtain information that may identify the capability of each electronic device through communication with the first other electronic device 201 and the second other electronic device 202 of the following vehicles 12 connected to the wireless network. Here, the capability information for identifying the capability of each electronic device is the number of cores of the processor mounted on the electronic devices, the operating clock speed of the central processing unit (CPU), the memory bandwidth, the CPU architecture, the number of stream processors of GPU, the GPU architecture, the GPU operating clock speed, memory bandwidth, float point operations per second (FLOPS), operations per second (OPS), which is performance information about the NPU.

In operation 713, the electronic device 100 may share a task between the other electronic devices 201 and 202 according to the identified capability information.

In an electronic device of the disclosure, the electronic device 100 of the leading vehicle 11 may allow AI-based computer vision processing of the second video and the third video generated from the first video obtained using the camera to be distributively processed by the first other electronic device 201 and the second other electronic device 202 using the capability information identified for the first other electronic device 201 and the second other electronic device 202. For example, the electronic device 100 may allocate AI-based computer vision processing for the second video to the first other electronic device 201, and AI-based computer vision processing for the third video to the second other electronic device 202.

In operation 714, the electronic device 100 may obtain a result of processing by each of the other electronic devices 201 and 202.

According to an embodiment, the electronic device 100 may obtain an AI-based computer vision processing result for the second video from the first other electronic device 201, and obtain an AI-based computer vision processing result for the third video from the second other electronic device 202. For example, the first other electronic device 201 may obtain the fourth information from the external object included in the second video and provide the fourth information to the electronic device 100. For example, the second other electronic device 202 may obtain the fifth information from the external object included in the third video and provide the fifth information to the electronic device 100.

In operation 715, the electronic device 100 may identify an external object using the processing result obtained from each of the other electronic devices 201 and 202.

According to an embodiment, the electronic device 100 may analyze a vision processing result for the second video obtained from the first other electronic device 201 and a vision processing result for the third video obtained from the second other electronic device 202. The electronic device 100 may be configured to identify an external object by comprehensively considering the vision processing result for the first video processed by the electronic device 100, the vision processing result for the second video, and the vision processing result for the third video processed by the other electronic devices 201 and 202. The electronic device 100 may provide the processing result to the user.

In an embodiment of the disclosure, the electronic device 100 may transfer the second video to the first other electronic device 201 to request the first other electronic device 201 to obtain the fourth information from the external object included in the second video, and transfer the third video to the second other electronic device 202 to request the second other electronic device 202 to obtain the fifth information from the external object included in the third video.

The operation of the electronic device 100 may correspond to a kind of distributed computing scheme in which each electronic device performs a workload for performing AI-based computer vision processing such as detection of an object in video or identification between the electronic device 100, the first other electronic device 201, and the second other electronic device 202 connected to the network.

In other words, the electronic device 100 of the leading vehicle 11 may control the first other electronic device 201 and the second other electronic device 202 to distributively process the AI-based computer vision processing task such as detection of an object in the first video which is the forward video obtained using the camera 140 of the leading vehicle 11, thereby relieving the electronic device 100 of work load.

In an embodiment of the disclosure, the electronic device 100, the first other electronic device 201, and the second other electronic device 202 may process the first video 601 which is the forward video obtained using the camera of the leading vehicle 11 and the second video 602 and the third video 603 generated from the first video using a distributed computing and/or edge computing scheme.

For video analysis through this distributed computing/edge computing scheme, the electronic device 100 may perform control to share the task among the electronic device 100, the first other electronic device 201, and the second other electronic device 202 and adjust computing resource allocations to complete a designated task.

As described above, according to an embodiment of the disclosure, the electronic device 100 may implement various technologies that may facilitate sharing a computing workload between several electronic devices (the first other electronic device 201 and the second other electronic device 202) interconnected through a distributed computing scheme.

In particular, since AI-based computer vision processing task requiring high computing capability has high requirements necessary to train and distribute a machine learning model, the above-described distributed computing function which shares the computation task among several electronic devices (nodes) may more efficiently process massive data sets and complicated algorithms. Therefore, when distributed computing is performed between the electronic devices 100, 201, and 202 connected to the network, as in the embodiment of the disclosure, the training process may be accelerated and real-time decision-making may be possible in AI applications.

FIG. 7C is a signal flowchart illustrating a procedure for discovering other electronic devices of other vehicles for requesting task sharing by an electronic device of a vehicle according to a distributed computing scheme.

The electronic device 720 of FIG. 7C may serve as a so-called master of the distributed computing system structure as a central entity that plays a role to allocate the task of identifying the information (e.g., an external object, etc.) necessary for driving the vehicle (e.g., computing calculation to identify an object from the image data obtained through the camera) to other electronic devices 722, 724, and 726 in a distributed computing scheme. Accordingly, the electronic device 720 according to an embodiment serves to control, coordinate, or manage the other electronic devices 722, 724, and 726 (so-called slaves) in order to share the task according to a distributed computing scheme. Specifically, the electronic device 720 may efficiently distribute the workload by allocating the task to the slaves 722, 724 and 726, and gathering the output, which is the result of the computing operation performed by each slave, to share the task according to the distributed computing scheme.

In operation 730, when data to be processed for distributed computing is generated, the electronic device 720 broadcasts discovery messages 732a, 732b, and 732c to discover electronic devices capable of performing the distributed computing operation in operation 732. In operation 732, the electronic device 720 may initiate a procedure of scanning the other electronic devices 722, 724, and 726 positioned around the electronic device 720 by broadcasting the discovery messages 732a, 732b, and 732c.

In this case, the electronic device 720 according to an embodiment may sense the entire discovery resource pool collectively in order to select a discovery resource.

In FIG. 7C, the first other electronic device 722 receiving the discovery message 732a transmits a discovery acknowledgment (ack) message 734a to the electronic device 720 in response thereto. Here, the discovery acknowledgment (Ack) message 734a may include at least one of unique identification information allocated to allow the electronic device 720 to identify the first other electronic device 722 in the network, position information of the first other electronic device 722, and a key value to be used for encryption/decryption of data to be transmitted/received with the electronic device 720 by the first other electronic device 720.

The second other electronic device 724 receiving the discovery message 732b may transmit a discovery acknowledgment (ack) message 734b to the electronic device 720 in response thereto. Here, the discovery acknowledgment (Ack) message 734b may include at least one of unique identification information allocated to allow the electronic device 720 to identify the second other electronic device 724 in the network, position information of the second other electronic device 724, and a key value to be used for encryption/decryption of data to be transmitted/received with the electronic device 720 by the second other electronic device 724.

The third other electronic device 726 receiving the discovery message 732c may transmit a discovery acknowledgment (ack) message 734c to the electronic device 720 in response thereto. Here, the discovery acknowledgment (Ack) message 734c may include at least one of unique identification information allocated to allow the electronic device 720 to identify the third other electronic device 726 in the network, position information of the third other electronic device 726, and a key value to be used for encryption/decryption of data to be transmitted/received with the electronic device 720 by the third other electronic device 726.

In operation 736, the electronic device 720 receiving the discovery acknowledgment messages 734a, 734b, and 734c may identify the other electronic devices 722, 724, and 726 using the information included in the discovery acknowledgment messages 734a, 734b, and 734c. Further, according to an embodiment, it is preferable that the electronic device 720 identifies capability information such as processor information, computing power, storage space size, and memory performance (memory bandwidth, memory size) of the identified other electronic devices 722, 724, and 726 in order to share the task for distributed computing processing of data generated in operation 730 among the other electronic devices 722, 724, and 726.

According to an embodiment, the processor information may include architecture information about the processor, central processing unit (CPU) information about the processor, graphic processing unit (GPU) information, neural network processing unit (NPU) information, cache information, or the like.

Accordingly, the electronic device 720 may transmit capability request messages 738a, 738b, and 738c for identifying capability information about the other electronic devices 722, 724, and 726 identified in operation 736, to the first other electronic device 722, the second other electronic device 724, and the third other electronic device 726, respectively.

The first other electronic device 722, the second other electronic device 724, and the third other electronic device 726 that have received the capability request messages 738a, 738b, and 738c may, in response thereto, transmit capability response messages 740a, 740b, and 740c including their capability information to the electronic device 720.

Here, the capability request message may include information shown in Table 1.

TABLE 1
Capability Request Message

| | | | Example of | |
|---|---|---|---|---|
| Field | | Description | Information | |
| Category | CPU Clocks | CPU maximum | 3 | GHz |
| | | operating clock | | |
| | | frequency | | |
| | | information | | |
| Central | CPU | Information about | | |
| Processing Unit | Architecture | the hardware | | |
| (CPU) | | configuration of | | |
| | | the CPU (e.g., | | |
| | | CPU | | |
| | | manufacturer, | | |
| | | CISC scheme, | | |
| | | RISC scheme, | | |
| | | CPU x86, | | |
| | | complex | | |
| | | instruction set | | |
| | | computing | | |
| | | (CISC), reduced | | |
| | | instruction set | | |
| | | computing | | |
| | | (RISC), ARM | | |
| | | Corex-A72 | | |
| | CPU | CPU developer | Intel, Apple, | |
| | manufacturer | | AMD, TESLA, | |
| | | | Ambarella, | |
| | | | Qualcomm, | |
| | | | Samsung etc. | |
| | Cache | | L1 Cache: | |
| | | | 192 + | |
| | | | 128 KB | |
| | | | L2 Cache: | |
| | | | 16 MB | |
| | Core | Number of cores | 16 | |
| | | (number of | (12(P-core) + | |
| | | performance | 4(E-core)) | |
| | | cores (P-cores), | | |
| | | number of | | |
| | | efficiency cores | | |
| | | (E-cores)) | | |
| | TDP (Thermal | Required | 36 | W |
| | Design Power) | operating power | | |
| Graphic | Architecture | GPU design | Maxwell | |
| Processing Unit | Core | Number of cores | 256 CUDA | |
| (GPU) | | | cores | |
| | TFLOPS (Tera | GPU performance | 1255 TFLOPS | |
| | Float point | index | | |
| | Operations Per | | | |
| | Second) | | | |
| NPU (Neural | Core | Number of cores | 16 | |
| Processing | TOPS (Trillion | NPU performance | 74 TOPS | |
| Unit) | Operation Per | index | | |
| | Second) | | | |
| System | RAM Size | RAM size | 16 | GB |
| Memory | RAM Clock | RAM operating | 5600 | MHz |
| | Speed | frequency | | |
| | Storage | Storage capacity | SSD 1TB | |
| Image | Frames/second | Image processing | 2,400 | |
| processing | | speed per second | frames/second | |
| speed | | | | |

| | | | |
|---|---|---|---|
| Software | OS | Operating system | Windows, Mac |
| | | | OS, Linux, |
| | | | Android, QNX |
| Communi- | Wireless | Supported | 802.11ax, 4G, |
| cation | Communication | wireless | 5G, Satellite |
| | | communication | communications |
| | | interface | |
| | | standards | |
| | I/F | Data interface | USB-C, USB |
| | | standards with | 3.0, Thunderbolt |
| | | external devices | |

The electronic device 720 receiving the capability response messages 740a, 740b, and 740c identifies the capability information about the other electronic devices 722, 724, and 726 in operation 742. Further, in operation 744, the electronic device 720 may identify an electronic device to share the task according to the identified operation information. For example, the electronic device 720 may use the capability information about the other electronic devices 722, 724, and 726 included in the capability response message to determine whether the other electronic devices 722, 724, and 726 may perform distributed computing tasks and the degree (amount) to which the distributed computing task is to be shared.

To that end, in an embodiment, the other electronic devices 722, 724, and 726 may include information elements (IE) requested by the electronic device 720 in the capability response messages 740a, 740b, and 740c as their capability information in the capability request message as shown in Table 1.

The electronic device 720 that identified electronic devices to share the task according to the capability information identified in operation 744 transfers (746a) the task allocated to the first other electronic device 722 and transfers (746b) the allocated task to the second other electronic device 724. FIG. 7C illustrates that after identifying the electronic devices to share the task in operation 744, the electronic device 720 transfers the allocated task only to the first other electronic device 722 and the second other electronic device 724 except for the third other electronic device 726. FIG. 7C illustrates an embodiment that may be performed when the electronic device 720 meets any one of the condition (condition 1) that the capability of the third other electronic device 726 may not meet the minimum requirement capable of performing the task sharing by distributed computing, the condition (condition 2) that the third other electronic device 726 may not perform the task sharing as it currently performs another task, and the condition (condition 3) that task sharing may be smoothly performed only by the first other electronic device 722 and the second other electronic device 724, as the result of identifying the information included in the capability response message received from the third other electronic device 726 in operation 744.

The first other electronic device 722 and the second other electronic device 724 receiving the allocated task (746a and 746b) from the electronic device 720 perform distributed computing tasks 748a and 748b, respectively, to complete the allocated tasks using their computing power. If the distributed computing task is completed in operations 748a and 748b, the first other electronic device 722 and the second other electronic device 724 transfer the task processing results to the electronic device 720, as in operations 750a and 750b.

In operation 752, the electronic device 720 receiving the task processing results from the first other electronic device 722 and the second other electronic device 724 performs data processing using a task processing result (distributed computing task 1) which is the computing operation result for the task allocated thereto, a task processing result (distributed computing task 2) which is the computing operation result transferred from the first other electronic device 722, and a task processing result (distributed computing task 3) which is the computing operation result transferred from the second other electronic device 724.

The operation flow (operation 730 to operation 752) from the time of generation of the data to be distributed computing-processed by the electronic device 720 to the time of completion of data processing using the task results of distributed computing processing by each electronic device as illustrated in FIG. 7C may be controlled by the electronic device 720 that serves as the master of the distributed computing system illustrated in FIG. 7C to be performed within a predetermined period (T) 770.

Further, in FIG. 7C, the operations in which the electronic device 720 transmits a discovery message to discover the other electronic devices to perform distributed computing tasks and receives a discovery acknowledgment message may be referred to as a scanning procedure 760. Further, FIG. 7C only illustrates that the other electronic devices 722, 724 and 726 transmit discovery acknowledgment messages 734a, 734b, and 734c to the electronic device 720, but this is merely an example and they may transmit a discovery not-acknowledgment message (Discovery Nack. Msg) that rejects the request for distributed computing task. In this case, the Discovery Nack. Msg may be determined by the other electronic device receiving the discovery message considering its computing power, current workload, network environment, resource information, or the like.

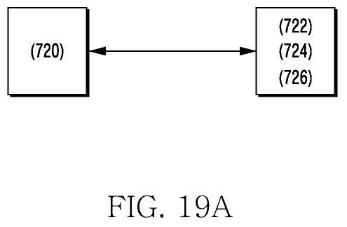

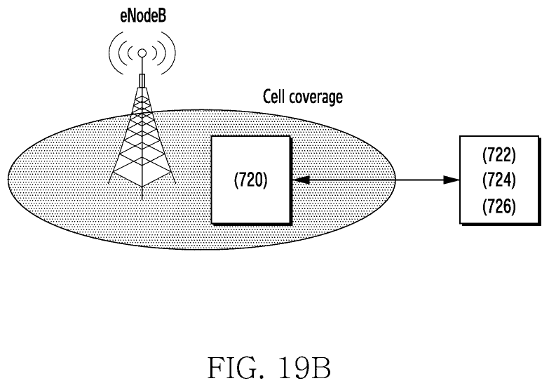

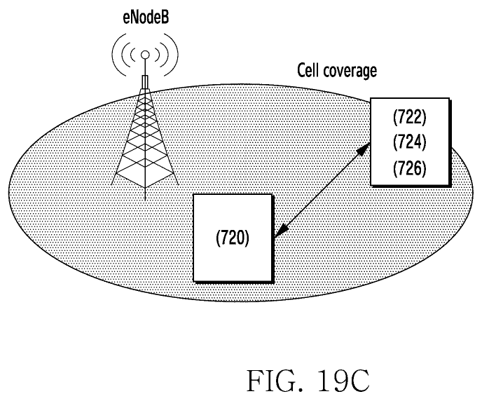

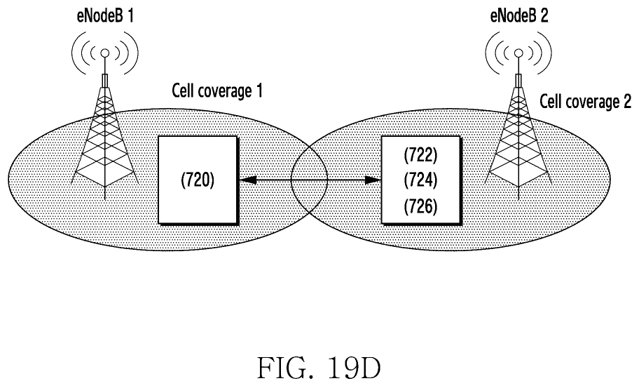

According to the above-described embodiment, in order to perform distributed computing between the electronic devices 720, 722, 724, and 726, radio resource allocation for direct communication between electronic devices 720, 722, 724, and 726 may be required. Wireless resource allocation for direct communication between the electronic devices 720, 722, 724, and 726 according to an embodiment is described with reference to FIG. 19 to be described below.

Hereinafter, the electronic device 100 for performing the operations is described.

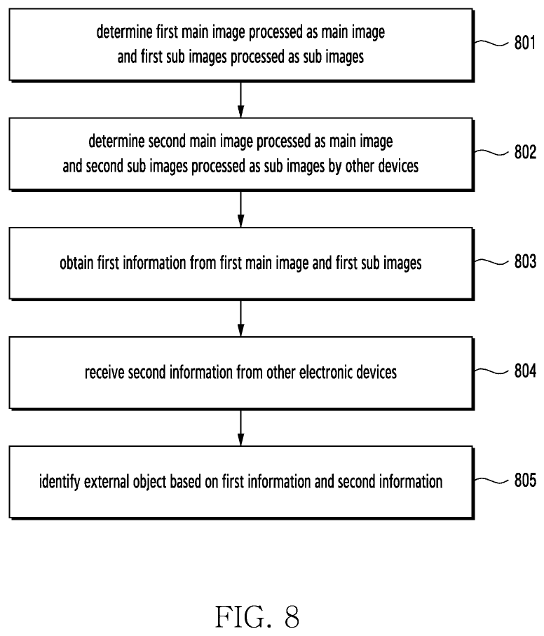

FIG. 8 is a flowchart illustrating an operation of identifying an external object based on a main video and sub videos by an electronic device according to an embodiment. FIG. 9 schematically illustrates a process of processing a main video and sub videos by the operations of FIG. 8;

The operations described in FIG. 8 may be operations of an electronic device (e.g., the electronic device 100 of FIG. 2) that are caused when instructions stored in the memory (e.g., the memory 120 of FIG. 2) are executed by the processor (e.g., the processor 110 of FIG. 2).

According to an embodiment, the forward video and the cropped videos may be distinguished into a main video and sub videos. In the disclosure, the main video may be referred to as a video processed by the electronic device 100 or the other electronic devices 200 based on a relatively high frame per second (FPS). In the disclosure, the sub videos, which are the remaining videos distinct from the main video, may be referred to as videos processed by electronic device 100 or the other electronic devices 200 based on a relatively low FPS. For example, if all videos are processed with the same FPS by processor 110 or processor 210, the identification speed of the external object (e.g., the external object 30 of FIG. 1) may be slowed down so, to mitigate this, the videos may be distinguished into a main video and sub videos. The electronic device 100 may differently allocate the main video to be processed by the processor 110 and the processor 210 and identify the external object 30 by comprehensively considering the first information and the second information.

Referring to FIG. 8, in operation 801, the electronic device 100 may determine a first main video processed as the main video and first sub videos processed as the sub videos.

For example, when executing the instructions stored in the memory 120, the processor 110 may distinguish the forward video and cropped videos into the first main video processed by the processor 110 based on the first FPS and first sub videos processed by the processor 110 based on the second FPS. The first main video may be referred to as a video processed as a main video by the electronic device 100. The first sub videos may be referred to as videos processed as sub videos by the electronic device 100 as at least some of the remaining videos except for the main video. For example, the first FPS may be 20 FPS to 40 FPS, and the second FPS may be 3 FPS to 5 FPS, but the disclosure is not limited thereto. In the disclosure, the operation of determining the main video and the sub videos may be referred to as an operation of allocating each of the videos to the main video or the sub videos.

For example, the processor 110 may determine the forward video as the first main video and determine the cropped videos as the second main video. For example, the processor 110 may determine the first video 601 as the first main video, and determine the second video 602 and the third video 603 as second sub videos. The first video 601 may be processed by the processor 110 based on the first FPS, and the second video 602 and the third video 603 may be processed by the processor 110 based on the second FPS. Since the first video 601 is processed based on the first FPS, it may be used as a leading means for identifying the external object 30 included in the first video 601. Since the second video 602 and the third video 603 are processed based on the second FPS, they may be used as an auxiliary means for the external object 30 included in the second video 602 and the third video 603.

In operation 802, the electronic device 100 may determine the second main video processed as the main video and the second sub videos processed as the sub videos by the other electronic devices.

For example, when executing the instructions stored in the memory 120, the processor 110 may distinguish the forward video and the cropped videos into the second main video processed by the processor 210 of each of the other electronic devices 200 based on the first FPS and the second sub videos processed by the processor 210 based on the second FPS. The second main video may be referred to as a video processed as the main video by the other electronic devices 200. The second sub videos may be referred to as videos processed as sub videos by the other electronic devices 200 as at least some of the remaining videos except for the main video.

For example, the processor 110 may determine one of the cropped videos as the second main video, and determine the forward video and the rest of the cropped videos as the second sub videos. For example, the processor 110 may determine the second video 602 as a main video, and determine the first video 601 and the third video 603 as sub videos. The second video 602 may be processed by the processor 210 based on the first FPS, and the first video 601 and the third video 603 may be processed by the processor 210 based on the second FPS. Since the second video 602 is processed based on the first FPS, it may be used as a leading means for identifying the external object 30 included in the second video 602. Since the first video 601 and the third video 603 are processed based on the second FPS, they may be used as an auxiliary means for the external object 30 included in the first video 601 and the third video 603. The second main video may be a video different from the first main video.

In operation 803, the electronic device 100 may obtain first information from the first main video and the first sub videos.

For example, when executing the instructions stored in the memory 120, the processor 110 may obtain first information related to the external object 30 by processing the first main video based on the first FPS and the second main video based on the second FPS. For example, when the first video 601 is determined as the first main video, the processor 110 may obtain the first information by processing the first video 601 based on the first FPS and processing the second video 602 and the third video 603 based on the second FPS. Since the first video 601 is processed based on the first FPS, it may have relatively high accuracy. Since the second video 602 and the third video 603 are processed based on the second FPS, they may have relatively low accuracy.

In operation 804, the electronic device 100 may receive second information from the other electronic devices 200.

For example, the other electronic devices 200 may obtain second information by processing the second main video based on the first FPS and processing the second sub videos based on the second FPS. For example, when the second video 602 is determined as the second main video, the processor 210 may obtain the second information by processing the second video 602 based on the first FPS and processing the first video 601 and the third video 603 based on the second FPS. Since the second video 602 is processed based on the first FPS, it may have relatively high accuracy. Since the first video 601 and the third video 603 are processed based on the second FPS, they may have relatively low accuracy. When executing instructions stored in the memory 120, the processor 110 may receive the second information obtained by the other electronic devices 200.

In operation 805, the electronic device 100 may identify the external object 30 based on the first information and the second information.

For example, when executing the instructions stored in the memory 120, the processor 110 may identify an external object 30 positioned in front of the leading vehicle 11 by comprehensively considering the first and second information.

According to an embodiment, the processor 110 may identify the external object 30 from the first information and the second information based on the main video and the sub videos. For example, the processor 110 may use the first information as a leading means and the second information as an auxiliary means to identify the external object 30 included in the first video 601. The second information may be used for cross-validation of the identification of the external object 30 included in the first video 601. For example, the processor 110 may use the second information as a leading means and use the first information as an auxiliary means to identify the external object 30 included in the second video 602. The first information may be used for cross-validation of the identification of the external object 30 included in the second video 602.

According to an embodiment, when the first information and the second information do not match, the processor 110 may identify the external object 30 based on information having high reliability. For example, when the external object 30 identified based on the first information and the external object 30 identified based on the second information are different, the processor 110 may identify the external object 30 based on information with higher reliability.

For example, information obtained based on the video processed as the main video may have the higher reliability than information obtained based on the video processed as sub videos. When the external object 30 identified based on the first information is different from the external object 30 identified based on the second information, the processor 110 may identify a video including the external object 30. For example, the processor 110 may identify which video the external object 30 is included in among the first video 601, the second video 602, and the third video 603. The external object 30 may be included in one or more videos. The processor 110 may identify whether the video including the external object 30 is the first main video or the second video 602. When the video is identified as the first main video, the processor 110 may identify the external object 30 based on the first information. When the video is identified as the second main video, the processor 110 may identify the external object 30 based on the second information. The electronic device 100 according to an embodiment may increase the accuracy of identification of the external object 30 by identifying the external object 30 based on information having high reliability.

According to an embodiment, when the first information and the second information do not match, the processor 110 may conservatively identify the external object 30. For example, when the distance between the external object 30 and the leading vehicle 11 is identified as 10m by the first information and the distance between the external object 30 and the leading vehicle 11 is identified as 5m by the second information, the processor 110 may identify the distance between the external object 30 and the leading vehicle 11 as 5m. Since the identification of the external object 30 is used to determine the driving route and driving control of the platooning, the processor 110 may conservatively identify the external object 30 to prevent an accident. In the disclosure, “the processor 110 conservatively identifies the external object 30” may mean including an operation in which when the distance (first identified distance) between the external object 30 and the vehicle identified by the first information and the distance (second identified distance) between the external object 30 and the vehicle identified by the second information are different from each other, the processor 110 determines that the distance, at which the possibility of collision between the vehicle and the external object 30 or the possibility of vehicle accident is lower, of the “first distance” and the “second distance” is information for vehicle driving control and autonomous driving. In other words, “conservative” may mean that when a plurality of pieces of different information are input, the processor 110 selects information that results in a lower possibility of vehicle accident. As in the above example, when the distance between the external object 30 and the leading vehicle 11 is identified as 10m or 5m, the electronic device 100 may be configured to identify the distance as 10m in order to reduce the possibility of an accident.

FIG. 9 illustrates a case in which the following vehicle includes a first following vehicle 911 and a second following vehicle 912. Referring to FIG. 9, the electronic device 100 disposed in the leading vehicle 11 may obtain a first video 601 and generate a second video 602 and a third video 603 from the first video 601. The electronic device 100 may transmit data including the first video 601, the second video 602, and the third video 603 to the first other electronic device 201 disposed in the first following vehicle 911 and the second other electronic device 202 disposed in the second following vehicle.

For example, the electronic device 100 may obtain information related to the external object 30 by processing the first video 601 as a main video (e.g., the first main video) and the second video 602 and the third video 603 as sub videos (e.g., first sub videos). For example, the first other electronic device 201 disposed in the first following vehicle 911 may obtain information related to the external object 30 by processing the second video 602 as a main video (e.g., the second main video) and the first video 601 and the third video 603 as sub videos (e.g., second sub videos). The first other electronic device 201 may transmit data including the information to the electronic device 100. For example, the second other electronic device 202 disposed in the second following vehicle may obtain information related to the external object 30 by processing the third video 603 as a main video (e.g., the third main video) and the first video 601 and the third video 602 as sub videos (e.g., third sub videos). The second other electronic device 202 may transmit data including the information to the electronic device 100.

According to an embodiment, the electronic device 100 may identify the external object 30 by comprehensively considering information. The video processed as the main video may be precisely analyzed by one of the electronic device 100, the first other electronic device 201, or the second other electronic device 202. A video processed as sub videos by some of the electronic device 100, the first other electronic device 201, or the second other electronic device 202 may be used for cross-validation of information obtained by processing the corresponding video as a main video.

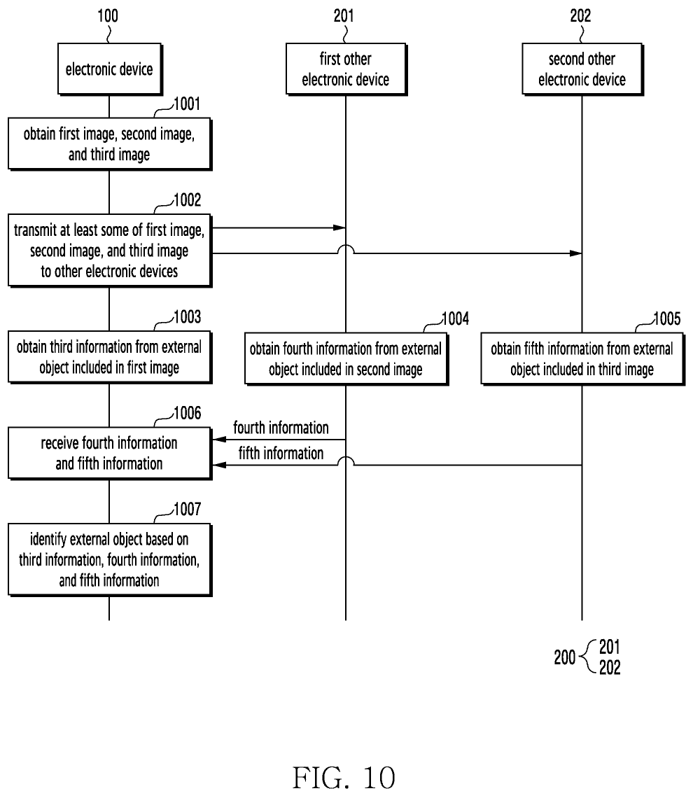

FIG. 10 is a flowchart illustrating operations of an electronic device using a plurality of cameras.

In the above-described examples, the electronic device 100 has been described as performing the operation of generating cropped videos from the forward video and transmitting the forward video and/or cropped videos to the other electronic devices 200, but the disclosure is not limited thereto. Alternatively, the camera 140 may include a plurality of cameras 141, 142 and 143 for capturing videos based on different fields of view. For example, the electronic device 100 may transmit at least some of the forward video obtained using each of the plurality of cameras 141, 142 and 143 to the other electronic devices 200. Other electronic devices 200 may obtain second information related to an external object (e.g., the external object 30 of FIG. 1) using the forward videos and transmit the obtained second information to the electronic device 100. The electronic device 100 may identify the external object 30 based on the first information obtained through at least one of the forward videos and the second information received from the other electronic devices 200. Hereinafter, the electronic device 100 including the plurality of cameras 141, 142 and 143 is described. The electronic device 100 described below may include substantially the same components as the above-described electronic device 100, and duplicate descriptions may be omitted.

The operations of FIG. 10 may be operations of an electronic device (e.g., the electronic device 100 of FIG. 2 and the other electronic devices 200) that are caused when instructions stored in the memory (e.g., the memory 120 and memory 220 of FIG. 2) are executed by a processor (e.g., the processor 110 and processor 210 of FIG. 2).

Referring to FIG. 10, in operation 1001, the electronic device 100 may obtain a first video (e.g., the first video 601 of FIG. 9), a second video (e.g., the second video 602 of FIG. 9), and a third video (e.g., the third video 603 of FIG. 9).

For example, when executing the instructions stored in the memory 120, the processor 110 may obtain the forward videos of the area in front of the leading vehicle 11 using each of the cameras 141, 142 and 143.

Referring back to FIGS. 6A, 6B, and 6C, the video (e.g., the first video 601 of FIG. 6A) may be referenced as an example of a video captured by the first camera 141, the video (e.g., the second video 602 of FIG. 6B) may be referenced as an example of a video captured by the second camera 142, and the video (e.g., the third video 603 of FIG. 6C) may be referenced as an example of a video captured by the third camera 143. For example, the first camera 141 may have a first field of view, and the first video 601 may be based on the first field of view. The second camera 142 may have a second field of view narrower than the first field of view, and the second video 602 may be based on the second field of view. The third camera 143 may have a third field of view, and the third video 603 may be based on the third field of view. According to an embodiment, the processor 110 may obtain the first video 601 through the first camera 141, obtain the second video 602 through the second camera 142, and obtain the third video 603 through the third camera 143.

In operation 1002, the electronic device 100 may transmit at least some of the first video 601, the second video 602, and the third video 603 to the other electronic devices 200.

For example, when executing the instructions stored in the memory 120, the processor 110 may transmit at least some of the first video 601, the second video 602, and the third video 603 to the other electronic devices 200 using the wireless communication device 130. For example, the processor 110 may transmit the second video 602 to the first other electronic device 201 and transmit the third video 603 to the second other electronic device 202, but the disclosure is not limited thereto.

According to an embodiment, the processor 110 may resize and transmit the forward videos to be transmitted in order to reduce the capacity of data. As the resized forward videos are transmitted, throughput processed through the wireless communication device 130 may be reduced. According to an embodiment, the processor 110 may resize the forward video to a size input to a neural network model of the other electronic devices 200. Since the other electronic devices 200 do not require high-resolution (e.g., 4K, full high definition (FHD)) videos to identify the external object 30 from the forward video, the processor 110 may compress the forward videos into below-HD videos and transmit the same.

In operation 1003, the electronic device 100 may obtain third information from the external object 30 included in the first video 601.

For example, when executing the instructions stored in the memory 120, the processor 110 may identify the external object 30 included in at least some of the first video 601, the second video 602, and the third video 603 and obtain third information about the external object 30.

For example, the processor 110 may identify the external object 30 from the first video 601. The external object 30 may be identified through a neural network model. The neural network model may extract the external object 30 from the first video 601 and identify the external object 30 based on pre-learned images. For example, the third information may include information related to the type, position, size, and/or current state of the external object 30.

In operation 1004, the first other electronic device 201 may obtain fourth information related to the external object 30 from the external object 30 included in the second video 602.

In operation 1005, the second other electronic device 202 may obtain fifth information related to the external object 30 from the external object 30 included in the third video 603.

For example, the processor 210 of the first other electronic device 201 may include fourth information related to the external object 30 from the second video 602. The processor 210 of the second other electronic device 202 may include fifth information related to the external object 30 from the third video 603. The first other electronic device 201 and the second other electronic device 202 may identify the external object 30 using the neural network model.

In operation 1006, the electronic device 100 may receive the fourth information from the first other electronic device 201 and the fifth information from the second other electronic device 202.

For example, when executing the instructions stored in the memory 120, the processor 110 may receive fourth information from the first other electronic device 201 and fifth information from the second other electronic device 202.

In operation 1007, the electronic device 100 may identify the external object 30 based on the third information, the fourth information, and the fifth information.

For example, when executing the instructions stored in the memory 120, the processor 110 may identify the external object 30 based on the third information obtained from the first video 601, the fourth information received from the first other electronic device 201, and the fifth information received from the second other electronic device 202.

According to an embodiment, the electronic device 100 may use the information (e.g., the fourth information and the fifth information) provided from the other electronic devices 200 to analyze the images obtained through the first camera 141, the second camera 142, and the third camera 143, thereby reducing data throughput, mitigating the burden of data processing, and accurately identifying the external object 30.

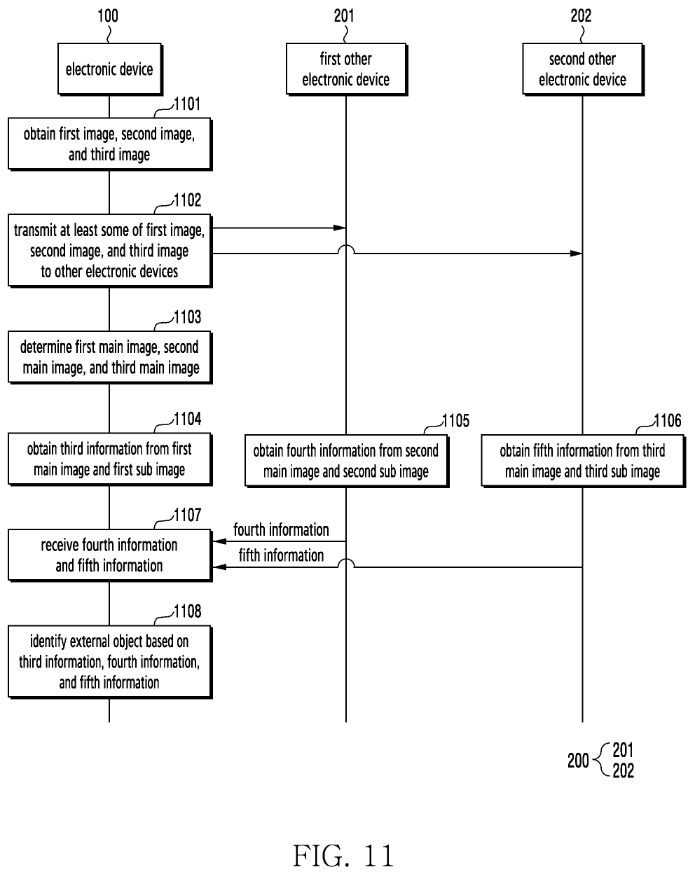

FIG. 11 is a flowchart illustrating an operation of identifying an external object based on a main video and sub videos by an electronic device according to an embodiment.

The operations of FIG. 11 may be operations of an electronic device (e.g., the electronic device 100 of FIG. 2 and the other electronic devices 200) that are caused when instructions stored in the memory (e.g., the memory 120 and memory 220 of FIG. 2) are executed by a processor (e.g., the processor 110 and processor 210 of FIG. 2).

According to an embodiment, the descriptions made above with reference to FIG. 8 may be applied in substantially the same manner to the electronic device 100 including a plurality of cameras 141, 142, and 143. For example, the electronic device 100 may distinguish and process the first video 601, the second video 602, and the third video 603 obtained through the plurality of cameras 141, 142, and 143, into main video and sub videos.

Referring to FIG. 11, in operation 1101, the electronic device 100 may obtain a first video 601, a second video 602, and a third video 603. Operation 1101 may correspond to operation 1001 of FIG. 10.

In operation 1102, the electronic device 100 may transmit at least some of the first video 601, the second video 602, and the third video 603 to the other electronic devices 200.

For example, when executing the instructions stored in the memory 120, the processor 110 may transmit at least some of the first video 601, the second video 602, and the third video 603 to the first and second other electronic devices 201 and 202. For example, the processor 110 may transmit all of the first video 601, the second video 602, and the third video 603 to the first other electronic device 201 and the second other electronic device 202.

In operation 1103, the electronic device 100 may determine a first main video, a second main video, and a third main video.

For example, when executing the instructions stored in the memory 120, the processor 110 may distinguish the forward videos (e.g., the first video 601, the second video 602, and the third video 603) into a first main video processed by the processor 110 based on the first FPS and first sub videos processed by the processor 110 based on the second FPS. The first main video may be referred to as a video processed as a main video by the electronic device 100. The first sub videos may be referred to as videos processed as sub videos by the electronic device 100 as at least some of the remaining videos except for the main video. For example, when executing the instructions stored in the memory 120, the processor 110 may distinguish the forward videos into a second main video processed by the first other electronic device 201 based on the first FPS and second sub videos processed by the first other electronic device 201 based on the second FPS. For example, when executing the instructions stored in the memory 120, the processor 110 may distinguish the forward videos into a third main video processed by the second other electronic device 202 based on the first FPS and third sub videos processed by the second other electronic device 202 based on the second FPS. For example, the first main video may be the first video 601, the second main video may be the second video 602, and the third main video may be the third video 603, but the disclosure is not limited thereto.

In operation 1104, the electronic device 100 may obtain third information from the first main video (e.g., the first video 601) and the first sub videos (e.g., the second video 602 and the third video 603).

For example, when executing the instructions stored in the memory 120, the processor 110 may process the first main video based on the first FPS and process the first sub videos based on the second FPS, thereby obtaining third information related to the external object (e.g., external object 30 of FIG. 1). For example, when the first video 601 is determined as the first main video, the processor 110 may obtain the third information by processing the first video 601 based on the first FPS and processing the second video 602 and the third video 603 based on the second FPS.

In operation 1105, the first other electronic device 201 may obtain fourth information from the second main video (e.g., the second video 602) and the second sub videos (e.g., the first video 601 and the third video 603).

For example, the first other electronic device 201 may obtain the fourth information by processing the second main video based on the first FPS and the second sub videos based on the second FPS. For example, when the second video 602 is determined as the second main video, the first other electronic device 201 may obtain the fourth information by processing the second video 602 based on the first FPS and processing the first video 601 and the third video 603 based on the second FPS.

In operation 1106, the second other electronic device 202 may obtain the fifth information from the third main video (e.g., the third video 603) and the third sub videos (e.g., the first video 601 and the second video 602).

For example, the second other electronic device 202 may obtain the fifth information by processing the third main video based on the first FPS and processing the third sub videos based on the second FPS. For example, when the third video 603 is determined as the third main video, the second other electronic device 202 may obtain the fifth information by processing the third video 603 based on the first FPS and processing the first video 601 and the second video 602 based on the second FPS.

In operation 1107, the electronic device 100 may receive the fourth information and fifth information.

For example, when executing the instructions stored in the memory 120, the processor 110 may receive fourth information obtained by the first other electronic device 201 and fifth information obtained by the second other electronic device 202.

In operation 1108, the electronic device 100 may identify the external object 30 based on the third information, the fourth information, and the fifth information. Operation 1108 may correspond to operation 805 of FIG. 8. For example, when executing the instructions stored in the memory 120, the processor 110 may identify an external object 30 positioned in front of the leading vehicle 11 by comprehensively considering third, fourth, and fifth information. The descriptions made for operation 805 may be applied in substantially the same manner to operation 1108.

In FIG. 11, the electronic device 100 transmits the first video 601, the second video 602, and the third video 603 to the other electronic devices 200 and distinguishes the videos into a main video and sub videos, but the disclosure is not limited thereto. For example, the electronic device 100 may transmit the first video 601 and the second video 602 to the first other electronic device 201, and transmit the second video 602 and the third video 603 to the second other electronic device 202. The electronic device 100 may determine the second main video and the second sub video, and determine the third main video and the third sub video. For example, the electronic device 100 may determine the first video 601 as the second main video and determine the third video 603 as the third main video. In this case, by distributed-processing the videos, data throughput of the other electronic devices 200 may be reduced.

According to an embodiment, the electronic device 100 may distinguish the first video 601, the second video 602, and the third video 603 respectively obtained by the plurality of cameras 141, 142, and 143 into the main video and sub videos, and process some of the first video 601, the second video 602, and the third video 603 using the other electronic devices 200, thereby reducing data throughput and accurately identifying the external object 30.

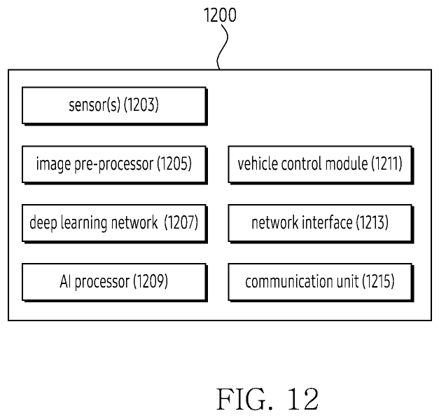

FIG. 12 is an example block diagram illustrating an autonomous driving system of a vehicle according to an embodiment.

The autonomous driving system 1200 of the vehicle according to FIG. 12 may be a deep learning network including sensors 1203, an image preprocessor 1205, a deep learning network 1207, an artificial intelligence (AI) processor 1209, a vehicle control module 1211, a network interface 1213, and a communication unit 1215. In various embodiments, each element may be connected via a variety of interfaces. For example, sensor data detected and output by the sensors 1203 may be fed to the image preprocessor 1205. The sensor data processed by the image preprocessor 1205 may be fed to the deep learning network 1207 run on the AI processor 1209. An output of the deep learning network 1207 run by the AI processor 1209 may be fed to the vehicle control module 1211. Intermediate results of the deep learning network 1207 run on the AI processor 1209 may be fed to the AI processor 1209. In various embodiments, the network interface 1213 communicates with an electronic device in the vehicle to transmit autonomous driving route information and/or autonomous driving control commands for autonomous driving of the vehicle to its internal block components. In an embodiment, the network interface 1213 may be used to transmit sensor data obtained through the sensor(s) 1203 to an external server. In some embodiments, the autonomous driving control system 1200 may include additional or fewer components as appropriate. For example, in some embodiments, the image preprocessor 1205 may be an optional component. As another example, a post-processing element (not shown) may be included in the autonomous driving control system 1200 to perform post-processing of the output of the deep learning network 1207 before the output is provided to the vehicle control module 1211.

In some embodiments, the sensors 1203 may include one or more sensors. In various embodiments, the sensors 1203 may be attached to various different positions of the vehicle. The sensors 1203 may be arranged to face one or more different directions. For example, the sensors 1203 may be attached to the front, sides, rear, and/or roof of the vehicle to face directions such as forward-facing, rear-facing, side-facing and the like. In some embodiments, the sensors 1203 may be image sensors such as e.g., high dynamic range cameras. In some embodiments, the sensors 1203 may include non-visual sensors. In some embodiments, the sensors 1203 may include a radar, a light detection and ranging (LiDAR), and/or ultrasonic sensors in addition to the image sensor. In some embodiments, the sensors 1203 are not mounted on the vehicle having the vehicle control module 1211. For example, the sensors 1203 may be incorporated as a part of a deep learning system for capturing sensor data and may be installed onto an environment or a roadway and/or mounted on surrounding vehicles.

In some embodiments, the image preprocessor 1205 may be used to preprocess sensor data of the sensors 1203. For example, the image preprocessor 1205 may be used to preprocess sensor data to split sensor data into one or more components, and/or to post-process the one or more components. In some embodiments, the image preprocessor 1205 may be any one of a graphics processing unit (GPU), a central processing unit (CPU), an image signal processor, or a specialized image processor. In various embodiments, the image preprocessor 1205 may be a tone-mapper processor for processing high dynamic range data. In some embodiments, the image preprocessor 1205 may be a component of the AI processor 1209.

In some embodiments, the deep learning network 1207 may be a deep learning network for implementing control commands for controlling the autonomous vehicle. For example, the deep learning network 1207 may be an artificial neural network such as a convolution neural network (CNN) trained using sensor data, and the output of the deep learning network 1207 is provided to the vehicle control module 1211.

In some embodiments, the AI processor 1209 may be a hardware processor for running the deep learning network 1207. In some embodiments, the AI processor 1209 may be a specialized AI processor adapted to perform inference on sensor data through a CNN. In some embodiments, the AI processor 1209 may be optimized for a bit depth of the sensor data. In some embodiments, the AI processor 1209 may be optimized for deep learning operations such as operations in neural networks including convolution, inner product, vector, and/or matrix operations. In some embodiments, the AI processor 1209 may be implemented through a plurality of graphics processing units (GPUs) capable of effectively performing parallel processing.

In various embodiments, the AI processor 1209 may be coupled, through an input/output interface, to a memory configured to provide an AI processor having instructions causing the AI processor to perform deep learning analysis on the sensor data received from the sensor(s) 1203 while the AI processor 1209 is executed, and determine a result of machine learning used to operate a vehicle at least partially autonomously. In some embodiments, the vehicle control module 1211 may be used to process commands for vehicle control outputted from the AI processor 1209, and to translate the output of the AI processor 1209 into commands for controlling modules of each vehicle in order to control various modules in the vehicle. In some embodiments, the vehicle control module 1211 is used to control an autonomous driving vehicle. In some embodiments, the vehicle control module 1211 may adjust the steering and/or speed of the vehicle. For example, the vehicle control module 1211 may be used to control driving of a vehicle such as e.g., deceleration, acceleration, steering, lane change, keeping lane or the like. In some embodiments, the vehicle control module 1211 may generate control signals for controlling vehicle lighting, such as e.g., brake lights, turns signals, and headlights. In some embodiments, the vehicle control module 1211 may be used to control vehicle audio-related systems such as e.g., a vehicle's sound system, vehicle's audio warnings, a vehicle's microphone system, and a vehicle's horn system.

In some embodiments, the vehicle control module 1211 may be used to control notification systems including alert systems for notifying passengers and/or a driver of driving events, such as e.g., approaching an intended destination or a potential collision. In some embodiments, the vehicle control module 1211 may be used to adjust sensors such as the sensors 1203 of the vehicle. For example, the vehicle control module 1211 may control to modify the orientation of the sensors 1203, change the output resolution and/or format type of the sensors 1203, increase or decrease a capture rate, adjust a dynamic range, and adjust the focus of the camera. In addition, the vehicle control module 1211 may control to turn on/off the operation of the sensors individually or collectively.

In some embodiments, the vehicle control module 1211 may be used to change the parameters of the image preprocessor 1205 by means of modifying a frequency range of filters, adjusting features and/or edge detection parameters for object detection, adjusting bit depth and channels, or the like. In various embodiments, the vehicle control module 1211 may be used to control autonomous driving of the vehicle and/or driver assistance features of the vehicle.

In some embodiments, the network interface 1213 may serve as an internal interface between the block components of the autonomous driving control system 1200 and the communication unit 1215. Specifically, the network interface 1213 may be a communication interface for receiving and/or transmitting data including voice data. In various embodiments, the network interface 1213 may be connected to external servers via the communication unit 1215 to connect voice calls, receive and/or send text messages, transmit sensor data, update software of the vehicle to the autonomous driving system, or update software of the autonomous driving system of the vehicle.

In various embodiments, the communication unit 1215 may include various wireless interfaces of a cellular or WiFi type. For example, the network interface 1213 may be used to receive updates of the operation parameters and/or instructions for the sensors 1203, the image preprocessor 1205, the deep learning network 1207, the AI processor 1209, and the vehicle control module 1211 from an external server connected via the communication unit 1215. For example, a machine learning model of the deep learning network 1207 may be updated using the communication unit 1215. According to another embodiment, the communication unit 1215 may be used to update the operating parameters of the image preprocessor 1205, such as image processing parameters, and/or the firmware of the sensors 1203.

In another embodiment, the communication unit 1215 may be used to activate communication for emergency services and emergency contacts in an event of a traffic accident or a near-accident. For example, in a vehicle crash event, the communication unit 1215 may be used to call emergency services for help, and may be used to externally notify the crash details and the location of the vehicle to the designated emergency services. In various embodiments, the communication unit 1215 may update or obtain an expected arrival time and/or a location of destination.

According to an embodiment, the autonomous driving system 1200 illustrated in FIG. 12 may be configured as an electronic device of a vehicle. According to an embodiment, when an autonomous driving release event occurs from the user while performing the autonomous driving of the vehicle, the AI processor 1209 of the autonomous driving system 1200 may make a control to input information related to the autonomous driving release event to the training set data of the deep learning network, thereby controlling to train the autonomous driving software of the vehicle.

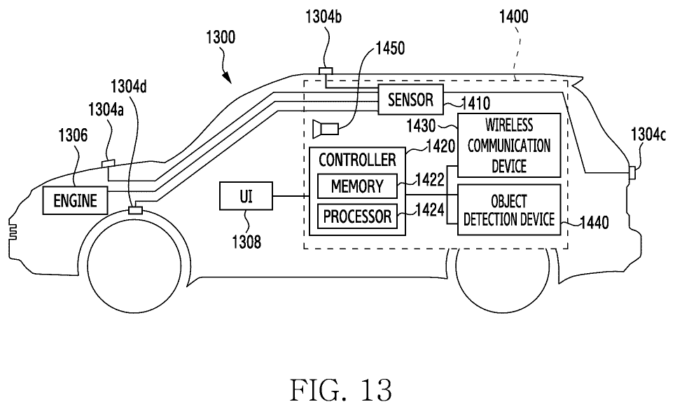

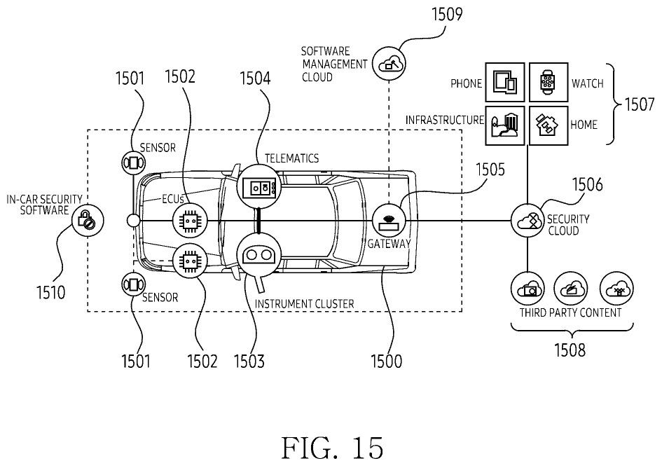

FIGS. 13 and 14 are example block diagrams illustrating an autonomous driving mobile body according to an embodiment. FIG. 15 illustrates an example of a gateway related to a user device according to various embodiments.

Referring to FIG. 13, the autonomous driving mobile body 1300 according to the present embodiment may include a control device 1400, sensing modules (1304a, 1304b, 1304c, 1304d), an engine 1306, and a user interface 1308.

The autonomous driving mobile body 1300 may have an autonomous driving mode or a manual mode. For example, according to a user input received through the user interface 1308, the manual mode may be switched to the autonomous driving mode, or the autonomous driving mode may be switched to the manual mode.

When the mobile body 1300 is operated in the autonomous driving mode, the autonomous driving mobile body 1300 may be operated under the control of the control device 1400.

In this embodiment, the control device 1400 may include a controller 1420 including a memory 1422 and a processor 1424, a sensor 1410, a communication device 1430, and an object detection device 1440.

Here, the object detection device 1440 may perform all or some of functions of the distance measuring device (e.g., the electronic device 100).

In other words, in the present embodiment, the object detection device 1440 is a device for detecting an object located outside the mobile body 1300, and the object detection device 1440 may be configured to detect an object located outside the mobile body 1300 and generate object information according to a result of the detection.

The object information may include information on the presence or absence of an object, location information of the object, distance information between the mobile body and the object, and relative speed information between the mobile body and the object.

The object may include various objects located outside the mobile body 1300, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1440 may include a camera module. The controller 1420 may extract object information from an external image captured by the camera module and allow the controller 1420 to process the information.

Further, the object detection device 1440 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1300 and the object, and control the operation of the mobile body based on the distance calculated in association with the control device 1400 of the autonomous driving mobile body 1300.

For example, when there is a possibility of collision depending upon the distance between the autonomous driving mobile body 1300 and the object, the autonomous driving mobile body 1300 may control the brake to slow down or stop. As another example, when the object is a moving object, the autonomous driving mobile body 1300 may control the driving speed of the autonomous driving mobile body 1300 to maintain a predetermined distance or more from the object.

The distance measuring device according to an embodiment of the disclosure may be configured as one module within the control device 1400 of the autonomous driving mobile body 1300. In other words, the memory 1422 and the processor 1424 of the control device 1400 may be configured to implement in software a collision avoidance method according to the present disclosure.

Further, the sensor 1410 may be connected to the sensing modules (1304a, 1304b, 1304c, 1304d) to obtain various sensing information about the environment inside and outside the mobile body. Here, the sensor 1410 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1410 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1410 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1410 may generate mobile body state information based on various detected data.

A wireless communication device 1430 may be configured to implement wireless communication between the autonomous driving mobile bodies 1300. For example, the autonomous driving mobile body 1300 can communicate with a mobile phone of the user or another wireless communication device 1430, another mobile body, a central apparatus (traffic control device), a server, or the like. The wireless communication device 1430 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1300 may implement wireless communication between mobile bodies via the wireless communication device 1430. In other words, the wireless communication device 1430 may communicate with another mobile body and other mobile bodies over the road through vehicle-to-vehicle (V2V) communication. The autonomous driving mobile body 1300 may transmit and receive information, such as driving warnings and traffic information, via the vehicle-to-vehicle communication, and may request information or receive such a request from another vehicle. For example, the wireless communication device 1430 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1430.

Further, the wireless communication device 1430 may obtain, as information for autonomous driving of the autonomous driving mobile body 1300, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1430 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1300.

For example, the wireless communication device 1430 may perform wireless communication with various platforms that configure a Non-Terrestrial Network (NTN) according to the wireless access specification complying with the 5G NR NTN (5th Generation New Radio Non-Terrestrial Network) standard currently being discussed in 3GPP and others, but the disclosure is not limited thereto.

In this embodiment, the controller 1420 may control the wireless communication device 1430 to select a platform capable of appropriately performing the NTN communication in consideration of various information, such as the location of the autonomous driving mobile body 1300, the current time, available power, and the like and to perform wireless communication with the selected platform.

In this embodiment, the controller 1420, which is a unit for controlling the overall operation of each unit in the mobile body 1300, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1420 configured at the time of its manufacturing. Such a controller 1420 may be referred to as an electronic control unit (ECU).

The controller 1420 may be configured to collect various data from the sensor 1410 connected thereto, the object detection device 1440, the communication device 1430, and the like, and may transmit a control signal based on the collected data to the sensor 1410, the engine 1306, the user interface 1308, the wireless communication device 1430, and the object detection device 1440 that are included as other components in the mobile body. Further, although not shown herein, the control signal may be also transmitted to an accelerator, a braking system, a steering device, or a navigation device related to driving of the mobile body.

According to the present embodiment, the controller 1420 may control the engine 1306, and for example, the controller 1420 may control the engine 1306 to detect a speed limit of the roadway on which the autonomous driving mobile body 1300 is driving and to prevent its driving speed from exceeding the speed limit, or may control the engine 1306 to accelerate the driving speed of the autonomous driving mobile body 1300 within a range not exceeding the speed limit.

Further, in case where the autonomous driving mobile body 1300 is approaching the lane or departing from the lane during the driving of the autonomous driving mobile body 1300, the controller 1420 may determine whether such approaching the lane or departing from the lane is due to a normal driving condition or other driving conditions, and control the engine 1306 to control the driving of the vehicle based on the result of determination. More specifically, the autonomous driving mobile body 1300 may detect lanes formed on both sides of the lane in which the vehicle is driving. In such a case, the controller 1420 may determine whether the autonomous driving mobile body 1300 is approaching the lane or departing from the lane, and if it is determined that the autonomous driving mobile body 1300 is approaching the lane or departing from the lane, then the controller 1420 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1300 is approaching or leaving the lane in a situation where it is not necessary for the mobile body to change the lane, the controller 1420 may control the driving of the autonomous driving mobile body 1300 such that the autonomous driving mobile body 1300 does not leave the lane and continue to drive normally in that lane.

When another mobile body or any obstruction exists in front of the mobile body, the controller may control the engine 1306 or the braking system to decelerate the mobile body, and control the trajectory, the driving route, and the steering angle of the mobile body in addition to the driving speed. Alternatively, the controller 1420 may control the driving of the mobile body by generating necessary control signals based on information collected from the external environment, such as, e.g., the driving lane of the mobile body, the driving signals, and the like.

In addition to generating its own control signals, the controller 1420 may communicate with a neighboring mobile body or a central server and transmit commands for controlling peripheral devices through the information received therefrom, thereby controlling the driving of the mobile body.

Further, when the position of the camera module 1450 changes or the angle of view changes, it may be difficult to accurately recognize the mobile body or the lane in accordance with the present embodiment, and thus the controller 1420 may generate a control signal for controlling to perform calibration of the camera module 1450 in order to prevent such a phenomenon. Accordingly, in this embodiment, the controller 1420 may generate a calibration control signal to the camera module 1450 to continuously maintain the normal mounting position, orientation, angle of view, etc. of the camera module 1450, even if the mounting position of the camera module 1450 is changed due to vibrations or impacts generated according to the movement of the autonomous driving mobile body 1300. The controller 1420 may generate a control signal to perform calibration of the camera module 1450, in case where the pre-stored initial information of mounting position, orientation, and angle of view of the camera module 1450 varies by more than a threshold value from the initial mounting position, direction, and angle of view information of the camera module 1450 measured during the driving of the autonomous driving mobile body 1300.

In this embodiment, the controller 1420 may include a memory 1422 and a processor 1424. The processor 1424 may execute software stored in the memory 1422 according to a control signal of the controller 1420. More specifically, the controller 1420 may store in the memory 1422 data and instructions for performing the lane detection method in accordance with the present disclosure, and the instructions may be executed by the processor 1424 to implement the one or more methods disclosed herein.

In such a circumstance, the memory 1422 may be included in a non-volatile recording medium executable by the processor 1424. The memory 1422 may store software and data through an appropriate internal and external device. The memory 1422 may be comprised of a random access memory (RAM), a read only memory (ROM), a hard disk, and another memory 1422 connected to a dongle.

The memory 1422 may store at least an operating system (OS), a user application, and executable instructions. The memory 1422 may also store application data, array data structures and the like.

The processor 1424 may be a microprocessor or an appropriate electronic processor, such as a controller, a microcontroller, or a state machine.

The processor 1424 may be implemented as a combination of computing devices, and the computing device may include a digital signal processor, a microprocessor, or an appropriate combination thereof.

Meanwhile, the autonomous driving mobile body 1300 may further include a user interface 1308 for a user input to the control device 1400 described above. The user interface 1308 may allow the user to input information with appropriate interaction. For example, it may be implemented as a touch screen, a keypad, a control button, etc. The user interface 1308 may transmit an input or command to the controller 1420, and the controller 1420 may perform a control operation of the mobile body in response to the input or command.

Further, the user interface 1308 may allow a device outside the autonomous driving mobile body 1300 to communicate with the autonomous driving mobile body 1300 through the wireless communication device 1430. For example, the user interface 1308 may be in association with a mobile phone, a tablet, or other computing devices.

Furthermore, this embodiment describes that the autonomous driving mobile body 1300 includes the engine 1306, but it may be also possible to include another type of propulsion system. For example, the mobile body may be operated with electrical energy or may be operable by means of hydrogen energy or a hybrid system in combination thereof. Thus, the controller 1420 may include a propulsion mechanism according to the propulsion system of the autonomous driving mobile body 1300, and may provide control signals to components of each of the propulsion mechanism accordingly.

Hereinafter, a detailed configuration of the control device 1400 according to the present embodiment will be described in more detail with reference to FIG. 14.

The control device 1400 includes a processor 1424. The processor 1424 may be a general-purpose single-chip or multi-chip microprocessor, a dedicated microprocessor, a microcontroller, a programmable gate array, or the like. The processor may be referred to as a central processing unit (CPU). In this embodiment, the processor 1424 may be implemented with a combination of a plurality of processors.

The control device 1400 also includes a memory 1422. The memory 1422 may be any electronic component capable of storing electronic information. The memory 1422 may also include a combination of memories 1422 in addition to a single memory.

Data and instructions 1422a for performing a distance measuring method of the distance measuring device according to the present disclosure may be stored in the memory 1422. When the processor 1424 executes the instructions 1422a, all or some of the instructions 1422a and the data 1422b required for executing the instructions may be loaded onto the processor 1424 (e.g., 1424a or 1424b).

The control device 1400 may include a transmitter 1430a, a receiver 1430b, or a transceiver 1430c for allowing transmission and reception of signals. The one or more antennas (1432a, 1432b) may be electrically connected to the transmitter 1430a, the receiver 1430b, or each transceiver 1430c, or may further include antennas.

The control device 1400 may include a digital signal processor (DSP) 1470. The DSP 1470 may allow the mobile body to quickly process digital signals.

The control device 1400 may include a communication interface 1480. The communication interface 1480 may include one or more ports and/or communication modules for connecting other devices to the control device 1400. The communication interface 1480 may allow the user and the control device 1400 to interact with each other.

Various components of the control device 1400 may be connected together by one or more buses 1490, and the buses 1490 may include a power bus, a control signal bus, a state signal bus, a data bus, and the like. Under the control of the processor 1424, the components may transmit information to each other via the bus 1490 and perform a desired function.

Meanwhile, in various embodiments, the control device 1400 may be related to a gateway for communication with a security cloud. Referring to FIG. 15, the control device 1400 may be related to a gateway 1505 for providing information obtained from at least one of components 1501 to 1504 of a vehicle 1500 to a security cloud 1506. For example, the gateway 1505 may be included in the control device 1400. As another example, the gateway 1505 may be configured as a separate device in the vehicle 1500 distinguished from the control device 1400. The gateway 1505 connects a software management cloud 1509 and a security cloud 1506, having different networks, with the network within the vehicle 1500 secured by in-car security software 1510, so that they can communicate with each other.

For example, a component 1501 may be a sensor. For example, the sensor may be used to obtain information about at least one of a state of the vehicle 1500 or a state around the vehicle 1500. For example, the component 1501 may include a sensor 1410.

For example, a component 1502 may be an electronic control unit (ECU). For example, the ECU may be used for engine control, transmission control, airbag control, and tire air-pressure management.

For example, a component 1503 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1500, visual elements for indicating a remaining fuel amount, visual elements for indicating a state of a transmission gear, or visual elements for indicating information obtained through the element 1501.

For example, a component 1504 may be a telematics device. For example, the telematics device may refer to an apparatus that combines wireless communication technology and global positioning system (GPS) technology to provide various mobile communication services, such as location information, safe driving or the like in the vehicle 1500. For example, the telematics device may be used to connect the vehicle 1500 with the driver, a cloud (e.g., the security cloud 1506), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1500.

For example, the gateway 1505 may be used to connect the in-vehicle network within the vehicle 1500 with the software management cloud 1509 and the security cloud 1506, which are out-of-vehicle networks. For example, the software management cloud 1509 may be used to update or manage at least one software required for driving and managing of the vehicle 1500. For example, the software management cloud 1509 may be associated with the in-car security software 1510 installed in the vehicle. For example, the in-car security software 1510 may be used to provide a security function in the vehicle 1500. For example, the in-car security software 1510 may encrypt data transmitted and received via the in-vehicle network, using an encryption key obtained from an external authorized server for encryption of the in-vehicle network. In various embodiments, the encryption key used by the in-car security software 1510 may be generated based on the vehicle identification information (vehicle license plate, vehicle identification number (VIN)) or information uniquely assigned to each user (e.g., user identification information).

In various embodiments, the gateway 1505 may transmit data encrypted by the in-car security software 1510 based on the encryption key, to the software management cloud 1509 and/or the security cloud 1506. The software management cloud 1509 and/or the security cloud 1506 may use a decryption key capable of decrypting the data encrypted by the encryption key of the in-car security software 1510 to identify from which vehicle or user the data has been received. For example, since the decryption key is a unique key corresponding to the encryption key, the software management cloud 1509 and/or the security cloud 1506 may identify a sending entity (e.g., the vehicle or the user) of the data based on the data decrypted using the decryption key.

For example, the gateway 1505 may be configured to support the in-car security software 1510 and may be related to the control device 1400. For example, the gateway 1505 may be related to the control device 1400 to support a connection between the client device 1507 connected to the security cloud 1506 and the control device 1400. As another example, the gateway 1505 may be related to the control device 1400 to support a connection between a third party cloud 1508 connected to the security cloud 1506 and the control device 1400. However, the disclosure is not limited thereto.

In various embodiments, the gateway 1505 may be used to connect the vehicle 1500 to the software management cloud 1509 for managing the operating software of the vehicle 1500. For example, the software management cloud 1509 may monitor whether update of the operating software of the vehicle 1500 is required, and may provide data for updating the operating software of the vehicle 1500 through the gateway 1505, based on monitoring that the update of the operating software of the vehicle 1500 is required. As another example, the software management cloud 1509 may receive a user request to update the operating software of the vehicle 1500 from the vehicle 1500 via the gateway 1505 and provide data for updating the operating software of the vehicle 1500 based on the received user request. However, the disclosure is not limited thereto.

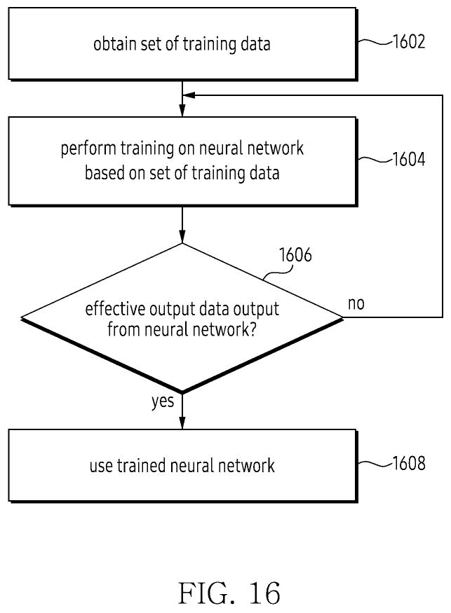

FIG. 16 is a view illustrating operations of an electronic device training a neural network based on a set of training data according to an embodiment.

The operations described with reference to FIG. 16 may be performed by the above-described electronic device (e.g., the electronic device 100 of FIG. 2).

Referring to FIG. 16, in operation 1602, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data.

The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1602 may include pairs of a plurality of training data. In the example of training the neural network for image recognition, the set of training data identified by the electronic device may include a plurality of images and ground truth data corresponding to each of the plurality of images.

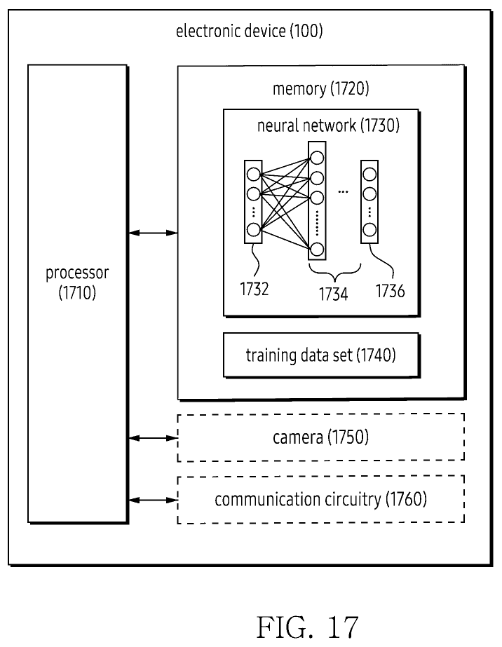

Referring to FIG. 16, in operation 1604, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 17. From the output layer of the neural network receiving the input data through the input layer, the electronic device may obtain output data of the neural network corresponding to the input data.

In an embodiment, the training of operation 1604 may be performed based on a difference between the output data and the ground truth data included in the training data and corresponding to the input data. For example, the electronic device may adjust one or more parameters (e.g., weights described below with reference to FIG. 17) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 16, in operation 1606, according to an embodiment, the electronic device may identify whether valid output data is output from the neural network trained in operation 1604. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1606), the electronic device may repeatedly perform training of the neural network based on operation 1604. The embodiments are not limited thereto, and the electronic device may repeatedly perform operations 1602 and 1604.

In a state in which valid output data is obtained from the neural network (Yes in 1606), based on operation 1608, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 17 is a block diagram illustrating an electronic device according to an embodiment; and

The electronic device 100 of FIG. 17 may include the above-described electronic device.

For example, the operations described with reference to FIG. 16 may be performed by the electronic device 100 of FIG. 17 and/or the processor 1710 of FIG. 17.

Referring to FIG. 17, a processor 1710 of the electronic device 100 may perform computations related to a neural network 1730 stored in a memory 1720. The processor 1710 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 17, the processor 1710 may identify the neural network 1730 stored in the memory 1720. The neural network 1730 may include a combination of an input layer 1732, one or more hidden layers 1734 (or intermediate layers), and an output layer 1736. The above-described layers (e.g., the input layer 1732, the one or more hidden layers 1734, and the output layer 1736) may include a plurality of nodes. The number of hidden layers 1734 may vary depending on embodiments, and the neural network 1730 including a plurality of hidden layers 1734 may be referred to as a deep neural network. Operation of training the deep neural network may be referred to as deep learning.

In an embodiment, when the neural network 1730 has a structure of a feed forward neural network, a first node included in a particular layer may be connected to all of second nodes included in another prior to that particular layer. In the memory 1720, the parameters stored for the neural network 1730 may include weights assigned to connections between the second nodes and the first node. In the neural network 1730 having such a structure of feedforward neural network, a value of the first node may correspond to a weighted sum of values assigned to the second nodes, based on weights assigned to connections connecting the second nodes and the first node.

In an embodiment, when the neural network 1730 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1720, the parameters stored for the neural network 1730 may include weights indicating the filter. The filter may include, among the second nodes, one or more nodes to be used to calculate a weighted sum of the first nodes, and weights corresponding to the one or more nodes, respectively.

According to an embodiment, the processor 1710 of the electronic device 100 may perform training on the neural network 1730, using the training data set 1740 stored in the memory 1720. Based on the training data set 1740, the processor 1710 may adjust one or more parameters stored in the memory 1720 for the neural network 1730.

According to an embodiment, the processor 1710 of the electronic device 100 may perform object detection, object recognition, and/or object classification, using the neural network 1730 trained based on the training data set 1740. The processor 1710 may input an image (or video) obtained through the camera 1750 to the input layer 1732 of the neural network 1730. Based on the input layer 1732 to which the image is input, the processor 1710 may sequentially obtain values of nodes of layers included in the neural network 1730 to obtain a set (e.g., output data) of values of nodes of the output layer 1736. The output data may be used based on a result of inferring information included in the image using the neural network 1730. Embodiments of the disclosure are not limited thereto, and the processor 1710 may input, to the neural network 1730, an image (or video) obtained from an external electronic device connected to the electronic device 100 through the communication circuit 1760.

In an embodiment, the neural network 1730 trained to process an image may be used to identify an area corresponding to a subject in the image (e.g., object detection) and/or identify a class of the subject represented in the image (e.g., object recognition and/or object classification). For example, the electronic device 100 may segment an area corresponding to the subject in the image, based on a rectangular shape such as e.g., a bounding box, using the neural network 1730. For example, the electronic device 100 may identify at least one class that matches the subject from among a plurality of specified classes, using the neural network 1730.

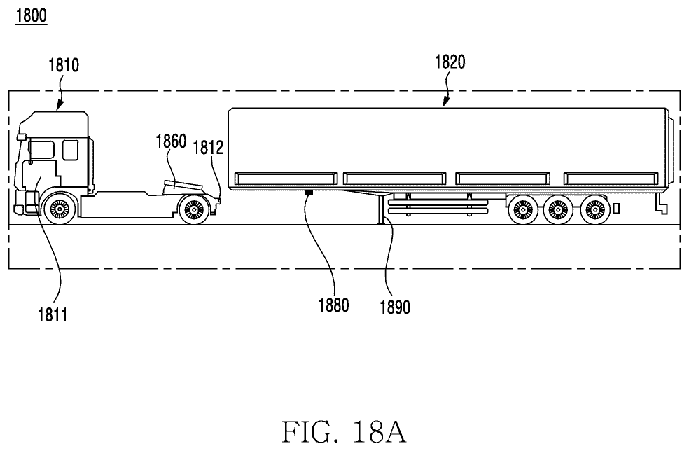

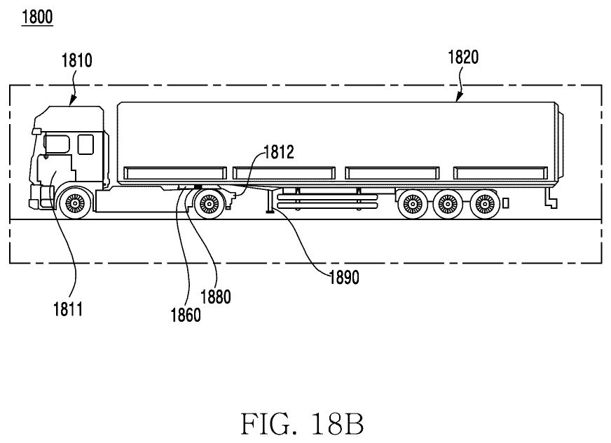

FIGS. 18A and 18B illustrate an example of a vehicle.

The above-described platooning vehicle may be referred to as a conventional truck.

Throughout the years, the trucking industry experienced steady growth and

expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

The trailer 1820 shown in FIGS. 18A and 18B of the disclosure is illustrated as a “semi-trailer”, but this is for convenience of description, and it should not be understood that the embodiments of the disclosure are applied only to a “semi-trailer” form.

Referring to FIGS. 18A and 18B, a vehicle 1800 including a tractor or tractor unit 1810 and a semi-trailer 1820 is exemplarily illustrated. FIG. 18A illustrates a state in which the tractor 1810 and the semi-trailer 1820 are not connected, and FIG. 18B illustrates a state in which the tractor 1810 and the semi-trailer 1820 are connected. In an embodiment, the semi-trailer 1820 may be selectively connected by a fifth wheel hitch 1860 carried by the tractor 1810, and the fifth wheel hitch 1860 may engage to the kingpin 1880 fixed to the semi-trailer 1820 in a known manner. The vehicle 1800 including the tractor 1810 and the semi-trailer 1820 may be referred to as a truck. The vehicle 1800 may include only the tractor 1810. The semi-trailer 1820 shown in FIGS. 18A and 18B is illustrated as a “semi-trailer” form, but this is for convenience of description, and it should not be understood that the embodiments of the disclosure are applied only to a “semi-trailer” form. The tractor 1810 shown in FIGS. 18A and 18B is illustrated as a “cab-over truck” form, but this is for convenience of description, and it should not be understood that the embodiments of the disclosure are applied only to a “cab-over truck” form.

In an embodiment, the tractor 1810 may include a front part 1811 and a rear part 1812. The front part 1811 may include a cab or cabin in which the driver sits. The rear part 1812 may be equipped with a fifth wheel hitch 1860 to which the semi-trailer 1820 is coupled. In an embodiment, the semi-trailer 1820 may include a king pin 1880 coupled to the fifth wheel hitch 1860 of the tractor 1810 and a landing gear 1890 that supports the semi-trailer 1820 against the ground when the semi-trailer 1820 is not coupled to the tractor 1810. The king pin 1880 and the landing gear 1890 may be installed on the lower portion of the semi-trailer 1820.

In an embodiment, the tractor 1810 may include an internal combustion engine, referred to as an engine, a motor, or a combination thereof. The tractor 1810 may include a battery and/or a fuel tank (e.g., a fuel tank designed to store gasoline, diesel, liquid natural gas (LNG), liquefied petroleum gas (LPG) and/or hydrogen). For example, the tractor 1810 including a rechargeable battery and a motor driven by electrical energy stored in the battery may be referred to as an electric vehicle (EV) and/or an electric truck. For example, the tractor 1810 including not only a battery and a motor but also a fuel tank and an engine may be referred to as a hybrid vehicle (e.g., plug-in hybrid electric vehicle (PHEV)).

In an embodiment, the semi-trailer 1820 may be coupled to or detached from the tractor 1810. For example, the semi-trailer 1820 may be connected to the rear part 1812 of the tractor 1810. The semi-trailer 1820 coupled to the tractor 1810 may be towed by the tractor 1810. To support driving on curved roads, the semi-trailer 1820 may be rotatably coupled to the tractor 1810. For example, the tractor 1810 and the semi-trailer 1820 may be rotatably coupled through a coupling device including the fifth wheel hitch 1860 and the king pin 1880. However, the link mechanism between the tractor 1810 and the semi-trailer 1820 is not limited thereto.

Described below is a radio resource allocation method for direct communication between electronic devices required to perform distributed computing task between an electronic device 720, a first other electronic device 722, a second other electronic device 724, and a third other electronic device 726 according to an embodiment of the disclosure, with reference to FIGS. 19A, 19B, 19C, and 19D.

Direct communication according to an embodiment of the disclosure may include communication not only between simple devices with communication functionality but also between other various types of devices with communication functionality, such as smartphones or personal computers.

FIGS. 19A, 19B, 19C, and 19D illustrate various scenarios for radio resource allocation for direct communication between electronic devices according to an embodiment.

The scenarios of direct communication between electronic devices, which may be applied according to an embodiment of the disclosure, may be largely divided into (1) an out-of-coverage network scenario, (2) a partial-coverage network scenario, and (3) an in-coverage network scenario, depending on whether an electronic device and other electronic devices are positioned in cell coverage/out-of-coverage.

FIG. 19A illustrates an example of the out-of-coverage network scenario of direct communication according to an embodiment. In the out-of-coverage network scenario, the electronic device 720 and the other electronic devices 722, 724, and 726 may communicate directly with each other without the control of the eNodeB.

FIG. 19B illustrates an example of the partial-coverage network scenario of direct communication according to an embodiment. The partial-coverage network scenario refers to direct communication between the electronic device 720 positioned in the network coverage of eNodeB and the other electronic devices 722, 724, and 726 positioned outside the network coverage of eNodeB.

FIGS. 19C and 19D illustrate examples of the in-coverage network scenario of direct communication according to an embodiment. The in-coverage network scenario of direct communication according to an embodiment may be divided into an in-coverage-single-cell network scenario (FIG. 19C) and an in-coverage-multi-cell network scenario (FIG. 19D) depending on whether the electronic device 720 and the other electronic devices 722, 724, and 726 that are to perform direct communication are positioned in the same cell coverage under the control of the same eNodeB.

In FIG. 19C, the electronic device 720 and the other electronic devices 722, 724, and 726 may perform direct communication under the control of the eNodeB in the same network coverage controlled by the same eNodeB.

In FIG. 19D, the electronic device 720 may be positioned in cell coverage 1 managed by eNodeB 1, and the other electronic devices 722, 724, and 726 may be positioned in cell coverage 2 managed by eNodeB 2, which is distinguished from eNodeB 1. FIG. 19D illustrates a scenario in which the cell in which the electronic device 720 is positioned and the cell in which the other electronic devices 722, 724, and 726 are positioned are controlled by different eNodeBs. In FIG. 19D, the electronic device 720 and the other electronic devices 722, 724, and 726 perform direct communication under the control of each eNodeB that manages cell coverage.

FIGS. 19A, 19B, 19C, and 19D illustrate examples of direct communication scenarios between the electronic devices 720, 722, 724, and 726 according to an embodiment of the disclosure, and in an actual direct communication environment between the electronic devices 720, 722, 724, and 726, the scenarios of FIGS. 19A, 19B, 19C, and 19D may be mixed.

Direct communication between electronic devices may generally operate in network coverage (in-coverage) and outside coverage (out-of-coverage). Links used for direct communication between electronic devices are collectively referred to as direct links.

In an embodiment of the disclosure, direct link transmission may operate in an uplink spectrum in the case of FDD and may operate in an uplink (or downlink) subframe in the case of TDD. Time division multiplexing (TDM) may be used for multiplexing of side link transmission and uplink transmission.

In an embodiment of the disclosure, it is assumed that side link transmission and uplink transmission do not occur at the same time. Further, it is assumed that the side link transmission and the downlink transmission also do not occur at the same time.

Direct communication procedures may be largely divided into a discovery procedure, a direct communication procedure, and a synchronization procedure.

### 1) Discovery

In FIG. 7C, since the electronic device 720 should play a role to transmit a discovery message, the electronic device 720 transmits a discovery message, and the other electronic devices 722, 724, and 726 receive the discovery message. Transmission and reception roles of the electronic device 720 and the other electronic devices 722, 724, and 726 may be exchanged. Transmission from the electronic device 720 may be received by one or more electronic device(s), such as the other electronic devices 722, 724, and 726.

The discovery message may include a single MAC PDU. The single MAC PDU may include an electronic device ID (e.g., UE ID) and an application ID. A physical sidelink discovery channel (PSDCH) may be defined as a channel for discovery message transmission. The structure of the PSDCH channel may reuse the PUSCH structure.

Further, in an embodiment, two types of resource allocation methods for discovery of direct communication may be used: type 1 and type 2.

In the case of type 1, the eNodeB may allocate resources for discovery message transmission in a non-UE specific manner. Specifically, according to an embodiment, a radio resource pool for discovery transmission and reception constituted of a plurality of subframes may be allocated in a specific cycle, and the electronic device 720 that transmits the discovery message may arbitrarily select a specific resource in the radio resource pool and then transmit the discovery message. The periodic discovery resource pool may be allocated for the transmission of discovery message in a semi-static manner. The configuration information about the discovery resource pool for discovery message transmission may include a discovery period, and the number of subframes (i.e., the number of subframes constituting the radio resource pool) that may be used for discovery message transmission in the discovery period.

In the case of the electronic device 720 positioned in the cell coverage as shown in FIGS. 19B, 19C, and 19D, the discovery resource pool for discovery message transmission may be set by the eNodeB, and the eNodeB may inform the electronic device 720 of information about the discovery resource pool using RRC signaling (e.g., system information block (SIB)).

The discovery resource pool allocated for the transmission and reception of discovery messages in one discovery period may be multiplexed via TDM and/or FDM into time-frequency resource blocks of the same size, and the time-frequency resource blocks of the same size may be referred to as “discovery resources.” The discovery resource may be used by one electronic device for transmission of the discovery MAC PDU. The transmission of MAC PDU transmitted by one electronic device may be repeated contiguously or non-contiguously in the discovery period (i.e., the radio resource pool).

In the case of type 2, a discovery resource for discovery message transmission may be allocated in an electronic device-specific manner. Type 2 may be further subdivided into type 2A and type 2B. Type 2A is a method in which the eNodeB allocates resources at each transmission time (instance) of the discovery message of the electronic device in the discovery period, and type 2B is a method of allocating resources in a semi-persistent manner.

In the case of type 2B, the electronic device RRC-connected to the eNodeB (RRC_CONNECTED) requests the eNodeB to allocate resources for discovery message transmission through RRC signaling. Further, the eNodeB may allocate resources through RRC signaling. When the electronic device transitions to the RRC_IDLE state or when the eNodeB withdraws resource allocation through RRC signaling, the electronic device may release the most recently allocated transmission resources. As described above, in the case of type 2B, radio resources may be allocated by RRC signaling, and activation/deactivation of radio resources allocated by the PDCCH may be determined. The radio resource pool for discovery message reception may be configured by the eNodeB, and the eNodeB may inform the electronic device of the radio resource pool for discovery message reception using RRC signaling (e.g., system information block (SIB)).

The electronic devices 722, 724, and 726 receiving the discovery message may monitor all of the above-described type 1 and type 2 discovery resource pools to receive the discovery message.

### 2) Direct Communication

When the electronic device 720 has a role of data transmission through direct communication, the electronic device 720 directly transmits data, and the first other electronic device 722, the second other electronic device 724, and the third other electronic device 726 directly receive data from the electronic device 720 through a direct link. The transmission and reception roles of the electronic device 720 and the first other electronic device 722, the second other electronic device 724, and the third other electronic device 726 may be exchanged. Direct data transmission from the electronic device 720 may be received by one or more electronic device(s), such as the first other electronic device 722, the second other electronic device 724, and the third other electronic device 726.

Discovery message transmission/reception and data transmission/reception for direct communication may be independently defined without being associated with each other. In other words, discovery message transmission/reception procedures may not be required for groupcast and broadcast direct communication. As such, when the discovery procedure (discovery message transmission/reception and transmission/reception of the response message) and the data transmission/reception procedure through direct communication are defined independently, the electronic devices 720, 722, 724, and 726 do not need to recognize adjacent electronic devices. In other words, in the case of groupcast and broadcast direct communication, not all of the receiving electronic devices (electronic devices that receive messages) in the group are required to be close to each other.

According to an embodiment, a physical side link shared channel (PSSCH) may be defined as a channel for transmitting data through direct communication between electronic devices 720, 722, 724, and 726. Further, a physical side link control channel (PSCCH) may be defined as a channel that transmits control information for direct communication (e.g., scheduling assignment (SA), transmission type, etc.).

Further, according to an embodiment, mode 1 and mode 2 may be used as resource allocation methods for direct communication between the electronic devices 720, 722, 724, and 726.

Mode 1: refers to a method in which the eNodeB schedules the resources for the electronic device to use to transmit data or control information for direct communication. Mode 1 may be applied to the electronic devices 720, 722, 724, and 726 positioned in-coverage as shown in FIGS. 19C and 19D. In mode 1, the eNodeB configures a resource pool required for direct communication. Here, the resource pool required for direct communication may be divided into a control information pool and a data pool. If the eNodeB schedules control information and data transmission resources in the pool configured for the transmitting electronic device (electronic device to transmit data) using the data control channel, the transmitting electronic device transmits control information and data to other receiving electronic devices using the allocated resources.

In mode 1, the transmitting electronic device requests a transmission resource from the eNodeB, and the eNodeB may schedule resource¬for transmission of control information and direct communication data. In other words, in the case of mode 1, the transmitting electronic device should be in the RRC CONNECTED state to perform direct communication. The transmitting electronic device may transmit a scheduling request to the eNodeB, and a buffer status report (BSR) procedure may be performed so that the eNodeB may determine the amount of resources requested by the transmitting electronic device in response thereto.

In mode 1, the receiving electronic devices may selectively decode data transmission related to the control information by monitoring the control information pool and decoding the control information related thereto. The receiving electronic device may not decode the data pool according to the result of decoding the control information.

Mode 2: This is a method in which the electronic device arbitrarily selects a specific resource from the resource pool in order to transmit data or control information for direct communication. Mode 2 may be applied to the other electronic devices 722, 724, and 726 of FIGS. 19A and 19B.

In mode 2, the resource pool for control information transmission and/or the resource pool for data transmission through direct communication may be pre-configured or may be configured semi-statically. The electronic device may receive the configured resource pool (time and frequency) and select a resource for direct communication transmission from the resource pool. In other words, in order to transmit control information, the electronic device may select a resource for transmitting control information from the control information resource pool. Further, the electronic device may select a resource from the data resource pool for direct communication data transmission.

### 3) Synchronization

According to an embodiment, the synchronization signal (or sidelink synchronization signal) for direct communication of the electronic devices 720, 722, 724, and 726 may be used for the electronic devices 720, 722, 724, and 726 to obtain time-frequency synchronization. In particular, when the electronic device is positioned outside the network coverage, control by the eNodeB is impossible, so that a new signal and procedure for establishing synchronization between the electronic devices may be defined.

The electronic device that periodically transmits a synchronization signal for performing direct communication between the electronic devices 720, 722, 724, and 726 may be referred to as a direct communication synchronization source. When the direct communication synchronization source is the eNodeB, the structure of the transmitted direct communication synchronization signal may be the same as that of PSS/SSS. When the direct communication synchronization source is not the eNodeB (e.g., when it is an electronic device or a satellite), the structure of the transmitted direct communication synchronization signal may be newly defined. The direct communication synchronization signal may be periodically transmitted with a period not smaller than 40 ms. Each electronic device may have multiple physical layer side link synchronization identifiers.

Before transmitting a direct communication synchronization signal, the electronic device may first search for the direct communication synchronization source. Further, If a direct communication synchronization source is discovered, the electronic device may obtain time frequency synchronization through a direct communication synchronization signal received from the discovered direct communication synchronization source. Further, the electronic device that has obtained the time frequency synchronization may transmit a direct communication synchronization signal to the other electronic devices.

Hereinafter, for convenience of description, an example of direct communication between electronic devices is described as direct communication between two electronic devices, but the scope of the disclosure is not limited thereto, and the same principle described in an embodiment may be applied to direct communication between two or more electronic devices.

According to an embodiment, there may be a scheme in which all electronic devices perform a discovery procedure in a decentralized manner (hereinafter referred to as a ‘decentralized discovery procedure’). The method of performing a direct communication discovery procedure in a decentralized manner refers to a scheme in which all of the electronic devices by themselves determine to select a discovery resource, rather than determining resource selection on one node (e.g., an eNB, an electronic device, etc.) like a centralized scheme, and transmit/receive a discovery message through the selected discovery resource. In the decentralized discovery scheme according to an embodiment, a discovery subframe (i.e., a ‘discovery resource pool’) for a discovery procedure among all the cellular uplink frequency time resources is fixedly (or exclusively) allocated, and the remaining areas may be composed of the conventional LTE uplink wide area network (WAN) subframe areas.

The discovery resource pool may be constituted of one or more subframes. Further, the discovery resource pool may be periodically allocated at a predetermined time interval (i.e., a ‘discovery period”). Further, the discovery resource pool may be repeatedly configured in one discovery period.

According to an embodiment, the electronic device 720 may select a resource (i.e., a ‘discovery resource’) for discovery message transmission thereof in the exclusively allocated discovery pool and transmit the discovery message through the selected resource.

The discovery process of the electronic device 720 according to an embodiment may include a three-step procedure including a resource sensing step for discovery message transmission, a resource selection step for discovery message transmission, and a discovery message transmission/reception step.

First, in the resource sensing step, all the electronic devices performing the discovery procedure receive (i.e., sense) all discovery messages in a decentralized manner (i.e., on their own) for one period (i.e., the discovery resource pool) of the discovery resource. In the resource selection step, the electronic device classifies low-energy-level resources among the sensed resources and randomly selects discovery resources in a predetermined range. In this case, the discovery resource may be constituted of one or more resource blocks having the same size, and may be multiplexed via TDM and/or FDM in the discovery resource pool.

In the resource selection step according to an embodiment, the reason why the electronic device selects a low energy level resource as the discovery resource may be that a low-energy level resource may be interpreted as meaning that the electronic devices do not use many direct communication discovery resources in the surroundings. In other words, this proves that there are not many terminals performing a direct communication discovery procedure that causes interference in the surroundings. Therefore, when a resource with a low energy level is selected, there is a high probability that the interference will be small when the discovery message is transmitted. Further, in an embodiment, the reason why electronic devices randomly select discovery resources in a predetermined range without selecting the lowest energy level is that there is a possibility that, if the lowest energy level is selected, the plurality of terminals are to select the same lowest energy level at the same time. In other words, a lot of interference may be caused by selecting resources corresponding to the same lowest energy level. Therefore, it is preferable to randomly select (i.e., configure a candidate pool of selectable resources) in a predetermined range.

Further, the electronic device transmits and receives discovery messages based on the selected discovery resource after one period, and in subsequent discovery periods, it may periodically transmit and receive discovery messages based on a random resource hopping pattern.

The direct communication discovery procedure according to an embodiment may be performed not only in the RRC CONNECTED state in which the electronic device is connected to the eNodeB, but also in the RRC_IDLE state in which the electronic device is not connected to the eNodeB. Considering the above-described discovery scheme, all of the electronic devices may sense all resources (i.e., the discovery resource pool) transmitted by other nearby electronic devices and randomly select discovery resources in a predetermined range.

Here, the electronic device may adaptively determine the size of the discovery resource area according to the energy level, and may arbitrarily determine the position of the discovery resource area. For example, the electronic device may arbitrarily determine the position of the discovery resource area using its own identifier.

Further, the start position of the discovery resource area in the time, frequency, or space area may be fixed. In other words, the size of the discovery resource area may be variably determined according to the detected energy level, but it may start at a preset point in the frequency, time, or space area. For example, when the discovery resource area is adaptively determined in the frequency area, the position of the discovery resource area may be determined starting with a preset physical resource block (PRB) index in the discovery resource pool.

Further, according to an embodiment, the electronic device may sense discovery resources in the determined discovery resource area and select resources for transmission of discovery messages from among the sensed discovery resources. In other words, the electronic device may receive (i.e., sense) all the discovery messages transmitted in the selected discovery resources, classify low-energy level resources, and randomly select discovery resources in a predetermined range. Further, the electronic device may transmit a discovery message through the selected discovery resource and periodically transmit and receive the discovery message according to a random resource hopping pattern in the subsequent discovery period.

According to an embodiment, the discovery resource area may be dynamically set for each discovery resource pool, and may also be semi-statically set for each of one or more discovery periods. Further, the discovery resource area may be set cell-specifically and commonly applied to electronic devices belonging to the cell, and may be set UE-specifically for each electronic device.

The configuration information for the discovery resource area set as described above is system information such as a system information block (SIB) and a master information block (MIB) and may be periodically broadcast to the electronic devices. Further, it may also be transmitted to the electronic devices through RRC signaling or a physical layer channel (e.g., PDCCH or PDSCH).

There is provided an electronic device disposed in a leading vehicle among platooning vehicles. The electronic device may comprise a processor, memory storing instructions, and a camera. The instructions may, when executed by the processor, cause the electronic device to obtain a forward video related to an area in front of the leading vehicle, using the camera, generate cropped videos by cropping the forward video, transmit the forward video or at least one of the cropped videos to each of other electronic devices respectively disposed in following vehicles, obtain, from an external object included in the forward video or at least one of the cropped videos, first information related to the external object, receive, from the other electronic devices, second information related to the external object that is obtained from the external object included in the forward video or at least one of the cropped videos, and identify the external object, based on the first information and the second information.

According to an embodiment, the forward video may include a first video based on a first field of view. The cropped videos may include a second video based on a second field of view, generated by cropping a first region of the first video, and a third video based on a third field of view, generated by cropping a second region of the first video.

According to an embodiment, the instructions may, when executed by the processor, cause the electronic device to transmit at least one of the second video or the third video to each of the other electronic devices. The first information may include third information related to the external object identified from the external object included in the first video. The second information may include at least one of fourth information related to the external object identified from the external object included in the second video, or fifth information related to the external object identified from the external object included in the third video, received from the other electronic devices.

According to an embodiment, the instructions may, when executed by the processor, cause the electronic device to transmit the second video to a first other electronic device disposed in a first following vehicle among the following vehicles, transmit the third video to a second other electronic device disposed in a second following vehicle among the following vehicles, receive the fourth information from the first other electronic device, receive the fifth information from the second other electronic device, and identify the external object, based on the third information, the fourth information, and the fifth information.

According to an embodiment, the second field of view may be wider than the third field of view and may be narrower than the first field of view.

According to an embodiment, the instructions may, when executed by the processor, cause the electronic device to set a region of interest (ROI) based on a vanishing point of the forward video, and generate the cropped videos by cropping the forward video based on the RIO.

According to an embodiment, the instructions may, when executed by the processor, cause the electronic device to distinguish the forward video and cropped videos into a first main video processed by the electronic device based on a first frame per second (FPS) and first sub videos processed by the electronic device based on a second FPS lower than the first FPS, and obtain the first information, based on the first main video and the first sub videos.

According to an embodiment, the instructions may, when executed by the processor, cause the electronic device to distinguish the forward video and cropped videos into a second main video processed by each of the other electronic devices based on the first FPS and second sub videos processed by each of the other electronic devices based on the second FPS, transmit the forward video and cropped videos to each of the other electronic devices, and receive the second information, from the other electronic devices, obtained based on the second main video and the second sub videos.

According to an embodiment, the first main video may be a different video from the second main video.

According to an embodiment, the instructions may, when executed by the processor, cause the electronic device to identify a video in which the external object may be included, based on identifying that the external object identified based on the first information and the external object identified based on the second information may be different, identify whether the video may be the first main video or the second main video, identify the external object based on the first information, based on the identifying the video as the first main video, and identify the external object based on the second information, based on the identifying the video as the second main video.

According to an embodiment, the first information and the second information may be obtained using an image processing model (e.g., a neural network model).

There is provided an electronic device disposed in a leading vehicle among platooning vehicles. The electronic device may comprise a processor, memory storing instructions, and cameras. The instructions may, when executed by the processor, cause the electronic device to obtain forward videos related to an area in front of the leading vehicle, using each of the cameras, transmit the forward videos to each of other electronic devices respectively disposed in following vehicles, obtain, from an external object included in at least one of the forward videos, first information related to the external object, receive, from the other electronic devices, second information related to the external object that may be obtained from the external object included in at least one of the forward videos, and identify the external object, based on the first information and the second information.

According to an embodiment, the cameras may include a first camera with a first field of view, a second camera with a second field of view, and a third camera with a third field of view. The forward videos may include a first video, obtained by the first camera, based on the first field of view, a second video, obtained by the second camera, based on the second field of view, and a third video, obtained by the third camera, based on the third field of view.

According to an embodiment, the instructions may, when executed by the processor, cause the electronic device to transmit at least one of the second video or the third video to each of the other electronic devices. The first information may include third information related to the external object identified from the external object included in the first video. The second information may include at least one of fourth information related to the external object identified from the external object included in the second video, or fifth information related to the external object identified from the external object included in the third video, received from the other electronic devices.

According to an embodiment, the instructions may, when executed by the processor, cause the electronic device to transmit the second video to a first other electronic device disposed in a first following vehicle among the following vehicles, transmit the third video to a second other electronic device disposed in a second following vehicle among the following vehicles, receive the fourth information from the first other electronic device, receive the fifth information from the second other electronic device, and identify the external object, based on the third information, the fourth information, and the fifth information.

According to an embodiment, the instructions may, when executed by the processor, cause the electronic device to resize the second video and the third video to a designated size and transmit the second video and the third video.

According to an embodiment, the instructions may, when executed by the processor, cause the electronic device to transmit the first video, the second video, and the third video to a first other electronic device disposed in a first following vehicle among the following vehicles and a second other electronic device disposed in a second following vehicle among the following vehicles. The first information may include third information related to the external object obtained from the first video, the second video, and the third video. The second information may include fourth information related to the external object obtained from the first video, the second video, and the third video, the fourth information received from the first other electronic device, and fifth information related to the external object obtained from the first video, the second video, and the third video, the fifth information received from the second other electronic device.

According to an embodiment, the instructions may, when executed by the processor, cause the electronic device to distinguish the forward videos into a first main video processed by the electronic device based on a first frame per second (FPS) and first sub videos processed by the electronic device based on a second FPS lower than the first FPS, and obtain the third information, based on the first main video and the first sub videos.

The instructions may, when executed by the processor, cause the electronic device to distinguish the forward videos into a second main video processed by each of the other electronic devices based on the first FPS and second sub videos processed by each of the other electronic devices based on the second FPS, assign the second main video and the second sub videos to each of the other electronic devices, and receive the second information, from the other electronic devices, obtained based on the second main video and the second sub videos.

There is provided a method of an electronic device disposed in a leading vehicle among platooning vehicles. The method may comprise obtaining a forward video related to an area in front of the leading vehicle, using a camera of the electronic device, generating cropped videos by cropping the forward video, transmitting the forward video or at least one of the cropped videos to each of other electronic devices respectively disposed in following vehicles, obtaining, from an external object included in the forward video or at least one of the cropped videos, first information related to the external object, receiving, from the other electronic devices, second information related to the external object that may be obtained from the external object included in the forward video or at least one of the cropped videos, and identifying the external object, based on the first information and the second information.

What is claimed is:

1. An electronic device disposed in a leading vehicle among platooning vehicles, the electronic device comprising:
a processor;
memory storing instructions; and
a camera,
wherein the instructions, when executed by the processor, cause the electronic device to:
obtain a forward video related to an area in front of the leading vehicle, using the camera,
generate cropped videos by cropping the forward video,
transmit the forward video or at least one of the cropped videos to each of other electronic devices respectively disposed in following vehicles,
obtain, from an external object included in the forward video or at least one of the cropped videos, first information related to the external object,
receive, from the other electronic devices, second information related to the external object that is obtained from the external object included in the forward video or at least one of the cropped videos, and
identify the external object, based on the first information and the second information.

2. The electronic device of claim 1,
wherein the forward video includes a first video based on a first field of view, and
wherein the cropped videos include:
a second video based on a second field of view, generated by cropping a first region of the first video, and
a third video based on a third field of view, generated by cropping a second region of the first video.

3. The electronic device of claim 2,
wherein the instructions, when executed by the processor, cause the electronic device to transmit at least one of the second video or the third video to each of the other electronic devices,
wherein the first information includes third information related to the external object identified from the external object included in the first video, and
wherein the second information includes at least one of fourth information related to the external object identified from the external object included in the second video, or fifth information related to the external object identified from the external object included in the third video, received from the other electronic devices.

4. The electronic device of claim 3,
wherein the instructions, when executed by the processor, cause the electronic device to:
transmit the second video to a first other electronic device disposed in a first following vehicle among the following vehicles,
transmit the third video to a second other electronic device disposed in a second following vehicle among the following vehicles,
receive the fourth information from the first other electronic device,
receive the fifth information from the second other electronic device, and
identify the external object, based on the third information, the fourth information, and the fifth information.

5. The electronic device of claim 2,
wherein the second field of view is wider than the third field of view and is narrower than the first field of view.

6. The electronic device of claim 1,
wherein the instructions, when executed by the processor, cause the electronic device to:
set a region of interest (ROI) based on a vanishing point of the forward video, and
generate the cropped videos by cropping the forward video based on the RIO.

7. The electronic device of claim 1,
wherein the instructions, when executed by the processor, cause the electronic device to:
distinguish the forward video and cropped videos into a first main video processed by the electronic device based on a first frame per second (FPS) and first sub videos processed by the electronic device based on a second FPS lower than the first FPS, and
obtain the first information, based on the first main video and the first sub videos.

8. The electronic device of claim 7,
wherein the instructions, when executed by the processor, cause the electronic device to:
distinguish the forward video and cropped videos into a second main video processed by each of the other electronic devices based on the first FPS and second sub videos processed by each of the other electronic devices based on the second FPS,
transmit the forward video and cropped videos to each of the other electronic devices, and
receive the second information, from the other electronic devices, obtained based on the second main video and the second sub videos.

9. The electronic device of claim 8,
wherein the first main video is a different video from the second main video.

10. The electronic device of claim 8,
wherein the instructions, when executed by the processor, cause the electronic device to:
identify a video in which the external object is included, based on identifying that the external object identified based on the first information and the external object identified based on the second information are different,
identify whether the video is the first main video or the second main video,
identify the external object based on the first information, based on the identifying the video as the first main video, and
identify the external object based on the second information, based on the identifying the video as the second main video.

11. The electronic device of claim 1,
wherein the memory includes an image processing model used to extract the external object from the forward video and the cropped videos.

12. An electronic device disposed in a leading vehicle among platooning vehicles, the electronic device comprising:
a processor;
memory storing instructions; and
cameras,
wherein the instructions, when executed by the processor, cause the electronic device to:
obtain forward videos related to an area in front of the leading vehicle, using each of the cameras,
transmit the forward videos to each of other electronic devices respectively disposed in following vehicles,
obtain, from an external object included in at least one of the forward videos, first information related to the external object,
receive, from the other electronic devices, second information related to the external object that is obtained from the external object included in at least one of the forward videos, and
identify the external object, based on the first information and the second information.

13. The electronic device of claim 12,
wherein the cameras include:
a first camera with a first field of view,
a second camera with a second field of view, and
a third camera with a third field of view, and
wherein the forward videos include:
a first video, obtained by the first camera, based on the first field of view,
a second video, obtained by the second camera, based on the second field of view, and
a third video, obtained by the third camera, based on the third field of view.

14. The electronic device of claim 13,
wherein the instructions, when executed by the processor, cause the electronic device to transmit at least one of the second video or the third video to each of the other electronic devices,
wherein the first information includes third information related to the external object identified from the external object included in the first video, and
wherein the second information includes at least one of fourth information related to the external object identified from the external object included in the second video, or fifth information related to the external object identified from the external object included in the third video, received from the other electronic devices.

15. The electronic device of claim 14,
wherein the instructions, when executed by the processor, cause the electronic device to:
transmit the second video to a first other electronic device disposed in a first following vehicle among the following vehicles,
transmit the third video to a second other electronic device disposed in a second following vehicle among the following vehicles,
receive the fourth information from the first other electronic device,
receive the fifth information from the second other electronic device, and
identify the external object, based on the third information, the fourth information, and the fifth information.

16. The electronic device of claim 14,
wherein the instructions, when executed by the processor, cause the electronic device to resize the second video and the third video to a designated size and transmit the second video and the third video.

17. The electronic device of claim 13,
wherein the instructions, when executed by the processor, cause the electronic device to transmit the first video, the second video, and the third video to a first other electronic device disposed in a first following vehicle among the following vehicles and a second other electronic device disposed in a second following vehicle among the following vehicles,
wherein the first information includes third information related to the external object obtained from the first video, the second video, and the third video, and
wherein the second information includes:
fourth information related to the external object obtained from the first video, the second video, and the third video, the fourth information received from the first other electronic device, and
fifth information related to the external object obtained from the first video, the second video, and the third video, the fifth information received from the second other electronic device.

18. The electronic device of claim 13,
wherein the instructions, when executed by the processor, cause the electronic device to:
distinguish the forward videos into a first main video processed by the electronic device based on a first frame per second (FPS) and first sub videos processed by the electronic device based on a second FPS lower than the first FPS, and
obtain the third information, based on the first main video and the first sub videos.

19. The electronic device of claim 18,
wherein the instructions, when executed by the processor, cause the electronic device to:
distinguish the forward videos into a second main video processed by each of the other electronic devices based on the first FPS and second sub videos processed by each of the other electronic devices based on the second FPS,
assign the second main video and the second sub videos to each of the other electronic devices, and
receive the second information, from the other electronic devices, obtained based on the second main video and the second sub videos.

20. A method of an electronic device disposed in a leading vehicle among platooning vehicles, the method comprising:
obtaining a forward video related to an area in front of the leading vehicle, using a camera of the electronic device,
generating cropped videos by cropping the forward video,
transmitting the forward video or at least one of the cropped videos to each of other electronic devices respectively disposed in following vehicles,
obtaining, from an external object included in the forward video or at least one of the cropped videos, first information related to the external object,
receiving, from the other electronic devices, second information related to the external object that is obtained from the external object included in the forward video or at least one of the cropped videos, and
identifying the external object, based on the first information and the second information.
